(19) United States
(12) Patent Application Publication
(10) Pub. No.: US 2026/0148113 A1
(43) Pub. Date: May 28, 2026

(54) SYSTEM AND METHOD FOR BUILDING AND DEPLOYING PREDICTIVE MODELS USING MODULAR, MULTI-AGENT CONVERSATIONAL APPROACHES

(71) Applicant: PECAN AI LTD., Ramat Gan (IL)

(72) Inventors: Noam BREZIS, Hod-Hasharon (IL); Zohar Z. BRONFMAN, Tel-Aviv (IL); Tomer MERON, Raanana (IL)

(21) Appl. No.: 19/454,169

(22) Filed: Jan. 20, 2026

Related U.S. Application Data
(63) Continuation-in-part of application No. 18/905,783, filed on Oct. 3, 2024.
Application No. 18/905,783 is a continuation of application No. 18/312,778, filed on May 5, 2023, now Pat. No. 12,136,045.
Application No. 18/312,778 is a continuation of application No. 16/739,580, filed on Jan. 10, 2020, now Pat. No. 11,853,911.
(60) Provisional application No. 62/790,910, filed on Jan. 10, 2019.

(51) Int. Cl. G06N 5/04; G06F 16/22; G06N 20/00

(52) U.S. Cl. CPC G06N 5/04; G06F 16/2282; G06N 20/00

(57) ABSTRACT

Systems and methods applicable, for instance, to building and deploying predictive models using modular, multi-agent conversational approaches. A goals agent can perform actions including generating a guide data structure that can be used by other agents. An entity agent can perform actions including generating a data structure that contains entity identifiers and sampling dates. Further, a target/core set agent can perform actions including determining whether target activities occurred and calculating target values. Also, an attributes agent can perform actions including generating a training dataset. Additionally, a modeling agent can perform actions including outputting trained predictive models and performance reports.

### CROSS-REFERENCE TO RELATED APPLICATIONS

The present application is a continuation-in-part of U.S. application Ser. No. 18/905,783 filed on Oct. 3, 2024, which is a continuation of U.S. application Ser. No. 18/312,778 filed on May 5, 2023 (now U.S. Pat. No. 12,136,045), which is a continuation of U.S. application Ser. No. 16/739,580 filed on Jan. 10, 2020 (now U.S. Pat. No. 11,853,911), which claimed priority to U.S. Provisional Patent Application Ser. No. 62/790,910 filed on Jan. 10, 2019. The disclosures of these Applications are herein incorporated by reference in their entirety and for all purposes.

### FIELD

The present disclosure relates generally to the field of machine learning, and more specifically, but not exclusively, to systems and methods for building and deploying predictive models using modular, multi-agent conversational approaches.

### BACKGROUND

Conventional data structuring is being done manually. For example, for a conventional predictive analysis system, manual preparation of the data that is used to train a predictive model is required. This manual preparation can include preprocessing the data (e.g., compensating missing/broken values, normalizing data, and so on), feature engineering (e.g., application of functions and aggregations over the fields), splitting train, test, and validation sets from entire data sets, joining tables from the same data source or different data sources, and gathering all features into a structured table. This manual preparation can also include addressing data leakage and transforming 3D data into 2D data. These conventional solutions are not only time-consuming, but can only be done by experienced data scientists or artificial intelligence experts. Further, such manual preparation brings with it a risk of introducing human bias into the predictions which are generated by machine learning models.

However, automation of data structuring is a non-trivial task. For example, source data typically lacks information regarding its structure, meaning, and interrelationships. As another example, source data is often rife with missing and/or broken values which are not amenable to direct use by machine learning models. As yet another example, source data can often be polluted with “future” data, that is to say data of a sort that will not yet be available during the timeframe in which a machine learning model is to make predictions. Where such “future” data is included in training sets, a machine learning model can become misconfigured insofar as it can come to rely on information which will not be available to it when making predictions. For reasons such as these, conventional approaches typically resort to making data preparation a manual endeavor, despite the high concomitant financial and person-hour costs.

Further, building predictive machine learning models typically involves a complex and resource-intensive process that often draws on specialized expertise in data science, statistics, and programming. This process can include several stages, such as defining a business problem as a predictive question, sourcing and exploring data, sampling relevant entities, engineering features, training a model, and evaluating its performance. In many cases, each of these stages can present significant challenges and can require substantial technical knowledge. This can limit accessibility for less-technical users (e.g., business users) who might otherwise benefit from predictive insights.

Various automated machine learning platforms (e.g., AutoML) have been developed to address some of these challenges. However, these platforms typically exhibit various limitations, such as limitations regarding flexibility and/or interactive guidance. As such, these existing approaches can, for example, make it difficult for a user to translate their objectives (e.g., business objectives) into one or more technically robust predictive models.

Accordingly, there is a need for improved systems and methods for building and deploying predictive models using modular, multi-agent conversational approaches, in an effort to overcome the aforementioned obstacles and deficiencies of conventional approaches.

### BRIEF DESCRIPTION OF THE DRAWINGS

FIG. 1 is an exemplary top-level block diagram illustrating one embodiment of a data structuring system.

FIG. 2 is an exemplary diagram illustrating one embodiment of a screenshot for a graphical user interface which allows for selection of a prediction type/use case using the data structuring system of FIG. 1.

FIG. 3 is an exemplary diagram illustrating one embodiment of a screenshot for a graphical user interface which allows for provision of entity information using the data structuring system of FIG. 1.

FIG. 4A is an exemplary diagram illustrating one embodiment of a screenshot for a graphical user interface which allows for provision of target information using the data structuring system of FIG. 1.

FIG. 4B is an exemplary diagram illustrating another embodiment of a screenshot for a graphical user interface which allows for provision of target information using the data structuring system of FIG. 1.

FIG. 4C is an exemplary diagram illustrating one embodiment of a screenshot for a graphical user interface which allows for viewing and/or editing of system-generated queries using the data structuring system of FIG. 1.

FIG. 5 is an exemplary diagram illustrating one embodiment of a screenshot for a graphical user interface which allows for selection of attributes using the data structuring system of FIG. 1.

FIG. 6 is an exemplary diagram illustrating one embodiment of a screenshot for a graphical user interface which allows for viewing of various characterizations of prediction quality using the data structuring system of FIG. 1.

FIG. 7 is an exemplary diagram illustrating one embodiment of a screenshot for a graphical user interface which allows for requesting that predictions be generated using the data structuring system of FIG. 1.

FIG. 8 is an exemplary diagram illustrating one embodiment of a screenshot for a graphical user interface which allows for viewing and editing of queries using the data structuring system of FIG. 1.

FIG. 9 is a further exemplary diagram illustrating one embodiment of a screenshot for a graphical user interface which allows for viewing and/or editing of system-generated queries using the data structuring system of FIG. 1.

FIG. 10A is a further exemplary diagram illustrating one embodiment of three graphical user interfaces which allow for provision of target information using the data structuring system of FIG. 1.

FIG. 10B is a further exemplary diagram illustrating one embodiment of three graphical user interfaces which allow for selection of attributes using the data structuring system of FIG. 1.

FIG. 11 is an exemplary top-level block diagram illustrating one embodiment of a modular, multi-agent conversational system using the data structuring system of FIG. 1.

FIG. 12 is an exemplary diagram illustrating one embodiment of a screenshot for a graphical user interface which allows for interaction with a modular, multi-agent conversational system using the data structuring system of FIG. 1.

FIG. 13 is an exemplary diagram illustrating one embodiment of a screenshot for a graphical user interface which allows for interaction with a goals agent using the data structuring system of FIG. 1.

FIG. 14 is an exemplary diagram illustrating one embodiment of a screenshot for a graphical user interface which allows for interaction with an entity agent using the data structuring system of FIG. 1.

FIG. 15 is an exemplary diagram illustrating one embodiment of a screenshot for a graphical user interface which allows for interaction with a target agent (core set agent) agent using the data structuring system of FIG. 1.

FIG. 16 is an exemplary diagram illustrating one embodiment of a screenshot for a graphical user interface which allows for interaction with an attributes agent using the data structuring system of FIG. 1.

FIG. 17 is an exemplary diagram illustrating one embodiment of a screenshot for a graphical user interface which allows for interaction with a modeling agent using the data structuring system of FIG. 1.

FIG. 18 shows an exemplary computer.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

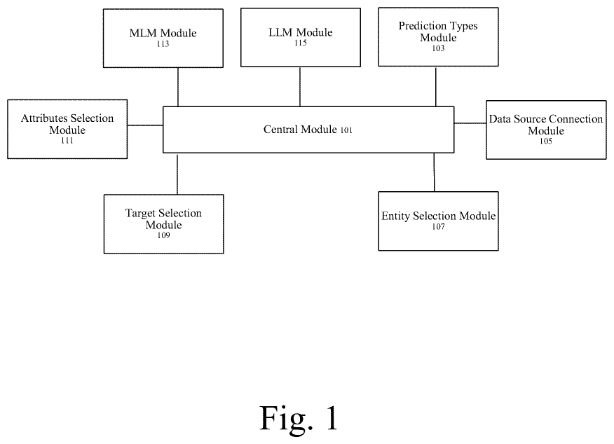

Since currently available artificial intelligence systems are deficient because they require manual preparation of source data that is often incomplete and/or lacks information regarding its structure, meaning, and interrelationships, a system for automated data structuring can prove desirable and provide a basis for a wide range of machine learning applications, such as fraud detection and predictive analysis. This result can be achieved, according to one embodiment disclosed herein, by a system 100 for data structuring as illustrated in FIG. 1. The systems disclosed herein overcome the non-trivial technical challenges encountered in previous attempts to automate data structuring for such applications, as discussed below in more detail, and achieve other beneficial results and technical improvements as will be appreciated by those of skill in the art.

According to various embodiments disclosed herein, one or more software modules can act in the selection of one or more features for a machine learning model (MLM). The one or more software modules can also act in the selection of the MLM, and in training the MLM. Various embodiments will now be discussed in greater detail.

As shown in FIG. 1, the one or more software modules can include a central module 101, a prediction types module 103, a data source connection module 105, an entity selection module 107, a target selection module 109, an attributes selection module 111, an MLM module 113, and a large language model (LLM) module 115. The LLM module 115 can, as just an example, include and/or interface with an LLM such as GPT-4.1 or GPT-5.

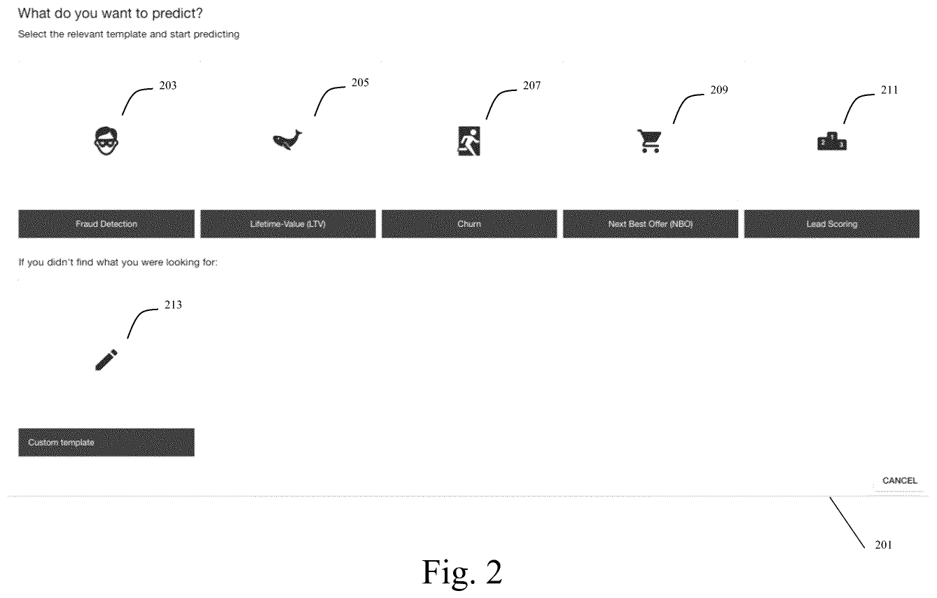

According to various embodiments, a user can access a user interface (UI), such as one displayed in connection with an app or a website. The UI can be generated by the central module 101. By employing the UI, the user can access various functionality provided by several of the software modules 101-113. Shown in FIGS. 2-10B are various example UI screens which can be provided via the UI. It is noted that, in various embodiments, an automated responsive code builder can be used in generating the UIs.

Turning to FIG. 2, shown is an example UI screen 201 which allows the user to select a desired prediction type/use-case. In particular, the UI of FIG. 2 allows the user to use displayed UI elements to select from among numerous prediction types/use cases, such as for example fraud detection 203, lifetime value (LTV) 205, customer churn 207, next best offer (NBO) 209, lead scoring 211, and custom prediction 213. The templates shown in the UI of FIG. 2 is for illustrative purposes only. Although not shown, the prediction types/use cases can further include inventory control, predictive maintenance, localization, sensor analysis, anomaly detection, credit score, risk/default, pricing optimization, fraud identification, financial projections, returning customers, user segmentation/profiling, net promoter score, and so on. The various prediction type choices offered to the user can be generated by the prediction types module 103. According to an illustrative example, the user can select customer churn 207.

According to various embodiments, the system can employ an LLM (e.g., a chat-based LLM) to aid the user in selecting their desired prediction type/use-case. Such functionality can be provided via the LLM module 115. As just an illustration, a prompt engineering approach can be used where the LLM is provided with a block of text. The block of text can provide descriptions of one or more of (e.g., descriptions of each of) the available prediction types/use-cases. As just an illustration, the description provided for the lead scoring prediction type/use-case can include indication that lead scoring involves ranking customers, in view of evidence, of their likelihood to make a purchase. It is noted that herein throughout where a prompt engineering approach is discussed, a fine-tuning approach can alternatively or additionally be used.

The prompt engineering approach can further include instructing the LLM that it recommend a prediction type/use-case to the user based on the provided block of text. Continuing with the illustration, the prompt engineering approach can also include instructing the LLM that it can ask the user up to a specified quantity of questions (e.g., up to five questions) before it recommends a prediction type/use-case. Also, the LLM can be instructed to not recommend a prediction type/use-case that is not in the block of text. In some embodiments, the LLM can be instructed to ask the questions one by one.

According to the illustration, in this way, the LLM can, after asking the user one or more questions, suggest a prediction type/use-case to the user. In some embodiments, the LLM can be configured (e.g., via a prompt engineering approach) to ask the user if they would like to proceed with the recommended prediction type/use-case. The LLM can also be configured to, where the user responds in the vein of “no,” continue querying until it recommends a prediction type/use-case that the user finds satisfactory. Further, the LLM can be configured to, where the use answers in the vein of “yes,” notify (e.g., via function calling capability of the LLM) the prediction types module 103 of the prediction type/use-case that is desired by the user. It is noted that, in various embodiments, the LLM can suggest multiple prediction types/use-cases. Also, in various embodiments the prompt engineering approach can include: a) the system taking a sample from data for which a prediction type/use-case is to be recommended; and b) the system instructing the LLM to recommend a prediction type/use-case to the user based on the data sample. In this way, various benefits can accrue, including helping to ensure that the LLM-recommended prediction type/use-case is well aligned with the relevant data.

Subsequent to selecting one of the offered prediction types, the user can be provided with a UI screen which allows the user to provide information regarding a data source which holds data concerning the predictions which the user desires to be made in connection with options 203-213. For instance, in the illustrative example where the user has selected customer churn 207, the data source can hold customer and/or sales data. The UI screen can allow the user to specify a type for the data source. The various data source types offered to the user can be generated by the data source connection module 105. Data sources which can be used by the system can include relational databases, Enterprise Resource Planning (ERP) systems, and Customer Relationship Management (CRM) systems, to name just a few. As one example, the UI screen can allow the user to select from the types: a) Structured Query Language (SQL) server; b) comma-separated values (CSV) file; c) Amazon Redshift; and d) Teradata. Further examples of data sources which can be used by the system include, but are not limited to, Microsoft Azure SQL DB, Google Big Query, Salesforce, Oracle, MySQL, PostgreSQL, and various non-structured databases (e.g., Elasticsearch and/or MongoDB). The UI screen can also prompt the user to provide information for connection to the data source. The information for which the user is prompted can be indicated by the data source connection module 105. For example, where the user has specified the data source to be an SQL server, the connection information can include a host/server identifier (e.g., via IP address or fully qualified domain name), a database name, and login credentials (e.g., user name and password). As another example, where the user has specified the data source to be a CSV file, the connection information can include a pathname and a file name. In some embodiments, the UI can allow the user to drag a file to the UI rather than explicitly (e.g., via keyboard entry) specifying the pathname and file name. The connection information provided by the user can be made available to the data source connection module 105. The data source connection module can use the connection information to access the data source. Although use of a single data source is discussed at various junctures herein, in various embodiments the system can access and draw data from multiple data sources.

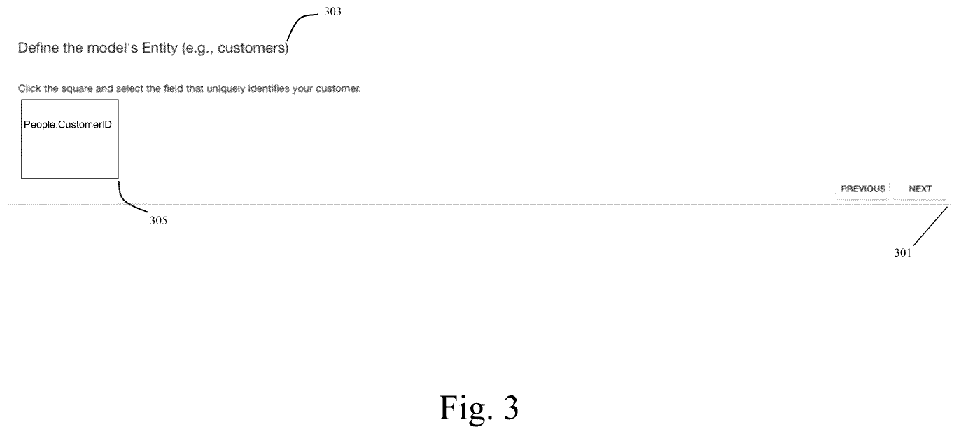

Turning to FIG. 3, shown is an example UI screen 300 which allows the user to provide information regarding “entities” which are to be the subject of the predictions to be made. For instance, in the illustrative example where the user has selected customer churn 207, the entities can be customers. Likewise, the entities can be customers where the user has selected LTV 205 or NBO 209. Where the user has selected fraud detection 203, the entities can be items which are potentially fraudulent (e.g., orders for products or services) and/or people who are potentially engaged in fraud (e.g., agents or cashiers). Where the use has selected lead scoring 211, the entities can be leads.

The UI screen 301 of FIG. 3 can request (303) that the user provide information regarding the entities. The entity selection module 107 can determine the information which the user is requested to provide. The information which the user is requested to provide can include an indication of a column which contains unique identifiers of the entities. The user can also be requested to provide an indication of table(s) which correspond to the column. For example, in the illustrative example where the user has selected customer churn 207, the user can be prompted for indication of a column which contains unique identifiers of customers. Likewise, the user can be prompted for indication of a column which contains unique identifiers of customers where the user has selected any one of LTV 205, NBO 209, or lead scoring 211. Where the user has selected fraud detection 203, the user can be prompted for indication of a column which contains unique identifiers of orders. More specifically, the user can be prompted to specify a primary key and table(s) which provide access to the column which contains the appropriate unique identifiers. Accordingly, in the illustrative example where the user has selected customer churn 207, the user might specify (305) “People.CustomerID” via the UI where the unique identifier of the entity was a customer identifier stored in a column accessible by a primary key CustomerID in a table People.

The information which the user is requested to provide can also include an indication of a column which contains time/date information for events which the user desires to serve as triggers for generating predictions. For instance, the user can be asked to provide such trigger information where the user selects any one of fraud detection 203, LTV 205, or lead scoring 211. In particular, the user can be prompted to specify a key and table(s) which provide access to the column which contains the time/date information. Accordingly, for example, suppose that fraud detection 203 is chosen. Here, the user might specify “Sales.OrderDate” via the UI where the event trigger information desired by the user were contained in a column accessible by a key OrderDate in a table Sales. In addition to selecting an event as a trigger for generating predictions, predictions can also be based on a predetermined schedule (e.g., repeated daily, monthly, or so on).

As one example, the user might specify tables and keys via keyboard entry. As another example, the user might specify tables via a drag-and-drop operation. For instance, the UI might allow the user to visually navigate to the People table, select the primary key CustomerID therefrom, and drop the selected primary key to a particular location on the UI.

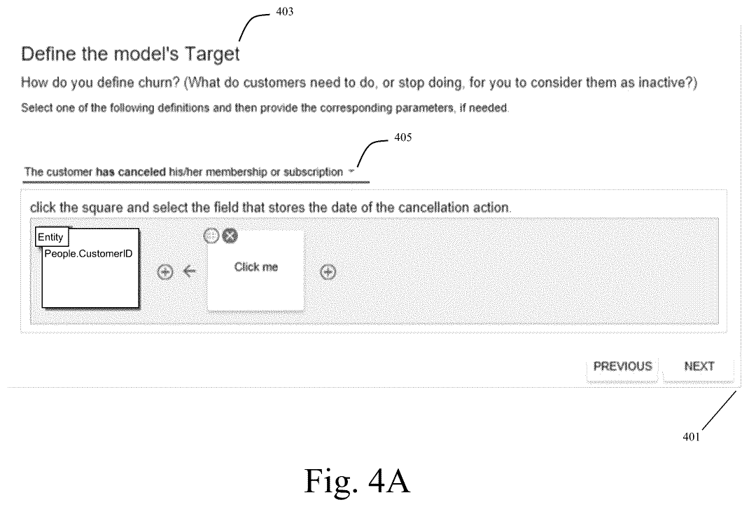

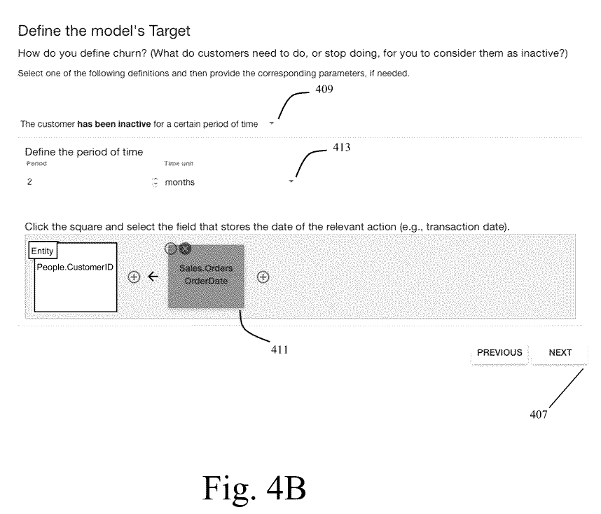

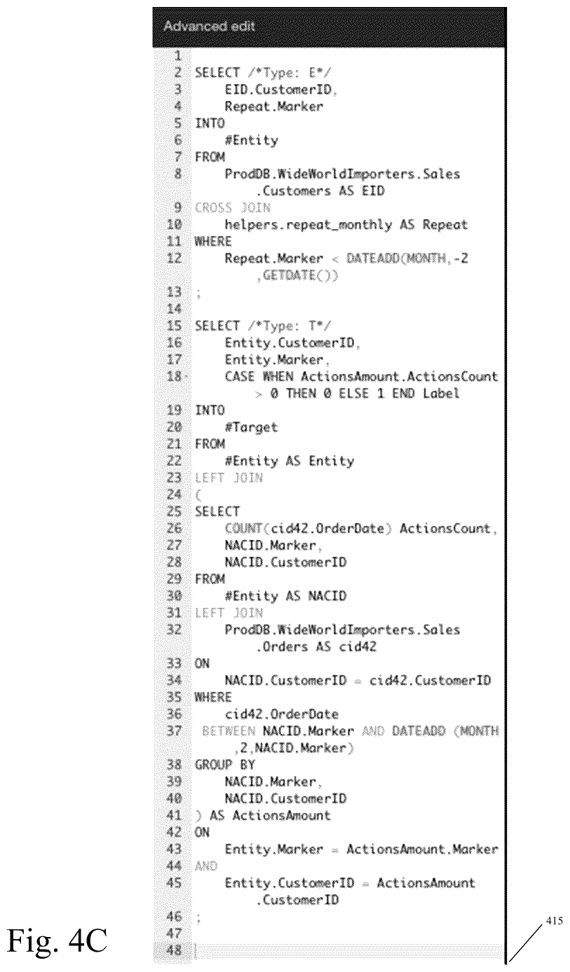

Turning to FIG. 4A, shown is an example UI screen 401 which allows the user to provide information regarding a “target,” the target being that which is to be predicted. For instance, in the illustrative example where the user has selected customer churn 207, the target can be whether or not churn appears likely in view of data input to the MLM. Likewise, where the user has selected fraud detection 203, the target can be whether or not fraud appears likely in view of data input to the MLM. Also, where the user has selected LTV 205, the target can be a predicted lifetime value in view of data input to the MLM. Further, where the user has selected NBO 209, the target can be a predicted subsequent purchase or other customer action in view of data input to the MLM. Additionally, where the user has selected lead scoring 211, the target can be whether or not conversion (e.g., a purchase being made) appears likely in view of data input to the MLM.

The UI screen 401 of FIG. 4A can request (403) that the user provide information regarding the target. The target selection module 109 can determine the information which the user is requested to provide. The information can include a selection of a particular one of several indicated descriptions of the target. The indication and selection of the descriptions can, for instance, be via a pulldown UI element, a UI text field element, and/or a UI checkbox element. The requested information can also include an indication of one or more columns which characterize the target. The user can additionally be requested to provide an indication of one or more tables which correspond to the one or more columns. The requested information can also include an indication of a timeframe which characterizes the target (e.g., the user could be able to provide such indication via a UI text field element and/or a pulldown UI element).

For instance, in the illustrative example where the user has selected customer churn 207, the user can be prompted to select from the following descriptions of the target: a) “The customer has cancelled his/her membership or subscription”; b) “The customer has been inactive for a certain period of time”; and c) “The customer has not reached a particular goal in a certain period of time.” Where the user selects (405) description “a),” the user can be prompted to specify a key and table(s) which provide access to the column which contains the date of the cancellation actions. As an illustration the user might specify Sales.CustomerCatagories.ValidTo the table “Sales,” the nested table “CustomerCategories,” and the column “ValidTo.” Where the user selects description “b),” the user can be prompted to indicate a timeframe for the period of time, and further to indicate a key and table(s) which provide access to the column which contains evidence of the inactivity. Where the user selects description “c),” the user can be prompted to indicate four items of information. Firstly, the timeframe for the period of time. Secondly, the particular goal (e.g., via a UI textfield). Thirdly, a key and table(s) which provide access to the column which contains a date for an achievement of the goal. And, fourthly, a key and table(s) which provide access to the column which contains information describing an achievement of the goal (e.g., a column indicating whether or not one dozen orders have been made).

Likewise, where the user has selected fraud detection 203, the user can be prompted to specify a key and table(s) which provide access to the column which contains data which indicates whether or not fraud has occurred. As an illustration, the user might indicate “Sales.Invoices.IsCreditNote” for a circumstance where such a column contains null data for non-fraudulent orders, and other than null data for fraudulent orders. As another example, where the user chose LTV 205, the user could be prompted to select from the following descriptions of the target: a) “The sum of all of the customer's spending in a specific amount of time”; b) “The number of the customer's actions in a specific amount of time”; c) “The sum of all of the customer's spending”; and d) “The number of the customer's actions.” Where the user selects description “a)” or “b),” the user can be prompted to indicate two items of information. Firstly, a timeframe for the “specific amount of time” Secondly a key and table(s) which provide access to a column which contains information describing LTV as defined by the user. As an illustration, where the user selected description “a),” the user might specify “Sales.CustomerTransactions.TransactionAmount.” Where the user selects “c)” or “d),” the user can be prompted to indicate a single item of information, in particular a key and table(s) which provide access to a column which contains information describing LTV as defined by the user. As such, where the user selects “c)” or “d),” the user is not prompted for a timeframe.

Also, where the user selects NBO 209, the user can be prompted to indicate a key and table(s) which provide access to a column which contains information describing NBO as defined by the user. As an illustration, the user might provide indication of a column containing a unique product identifier in the case where the user defined NBO as the purchase of a subsequent product. In some embodiments, the user can be provided which a checkbox which indicates whether or not to “Allow repeating products.” As an illustration, the user might check this box when the user wishes for the system to consider the possibility that a consumer might tend to purchase a particular product repeatedly. For example, a consumer might tend to purchase printer toner repeatedly. Finally, where the user selects lead scoring 211, the user can be prompted to indicate a key and table(s) which provide access to a column which contains information describing a conversion as defined by the users. In some embodiments, the system can indicate that such information be date information, such as a date when conversion of a customer occurred. As an illustration, the user might specify “Sales.Orders.OrderDate” where the user considered conversion of a customer to occur when a user placed an order for an item, such as an item for which advertisements had previously been displayed to the user.

It is noted that, in some embodiments, the user can be prompted to provide information for a join (e.g., a join wherein the condition of the join involves equality). For instance, the user can be prompted to provide information for a join when one or more columns specified by the user with respect to entity exist in a different table than one or more columns specified by the user with respect to target. In particular, the user can be prompted to indicate in one table (e.g., a table specified by the user in connection with entity) a primary and/or non-foreign key, and to indicate in a second table (e.g., a table specified by the user in connection with target) a corresponding foreign key. As an illustration, where the user specified a Customers table in connection with entity and a Purchases table in connection with target, the user might (e.g., via UI pulldowns) select primary key Customers.CustomerID for the first table and corresponding foreign key Purchases.Orders.CustomerID for the second table for an equality condition join. The user can also be prompted to select from among different types of joins (e.g., from among left, right and inner joins). In some embodiments, the system can use the results of such a join operation allowing a user to select—and/or receive automatic suggestion of—attributes for employment in connection with the MLM, as discussed hereinbelow.

With further regard to selection of the target by the user, in various embodiments a value specified by the user in connection with the target can a generated column, or otherwise be calculated on-the-fly rather than being directly stored in a data source. Turning to FIG. 4B, shown is a UI screen 407 where, in accordance with that which has been discussed above, the user has: a) selected customer churn 207; b) selected (409) “The customer has been inactive for a certain period of time”; c) indicated (411) “Sales.Orders.OrderDate” as holding relevant date information; and d) used the UI to indicate (413) the period of time to be two months. Here, the data source has a column which holds order dates (i.e., Sales.Orders.OrderDate), but does not have a column which indicates whether or not a customer has been active for two months. As such, the system can implement whether or not the customer has been active for two months as an on-the-fly calculation, in particular an on-the-fly calculation taking into account factors including Sales.Orders.OrderDate and the date when the calculation is performed. As discussed in greater detail below, in some embodiments the system can allow the user to view and/or edit the queries which have been generated by the system. Shown in FIG. 4C is a UI screen 415 allowing for such viewing and/or editing by the user, the UI screen 415 of FIG. 4C in particular allowing the user to view and/or edit code including code by which the system performs the on-the-fly calculation to determine whether or not a customer has been active for two months.

As referenced above, the UI screen 201 of FIG. 2 also allows the user to select custom prediction 213. According to various embodiments, where the user selects custom prediction 213 the user can, as discussed in connection with options 205-211, be presented with screens for selecting entity and target. However, the user might receive fewer and/or less detailed prompts from the system than those discussed in connection with options 205-211. For instance, the UI screen 301 of FIG. 3 might allow the user to directly indicate table(s) and keys for entity unique identifier, and the UI screen of FIG. 4A might allow the user to directly indicate one or more tables and keys for target, in absence of detailed system-generated prompts. According to various embodiments, where the user selects custom prediction 213, the system can allow the user to specify one or more corresponding SQL queries. As one example, such an SQL query can regard a target selected by the user.

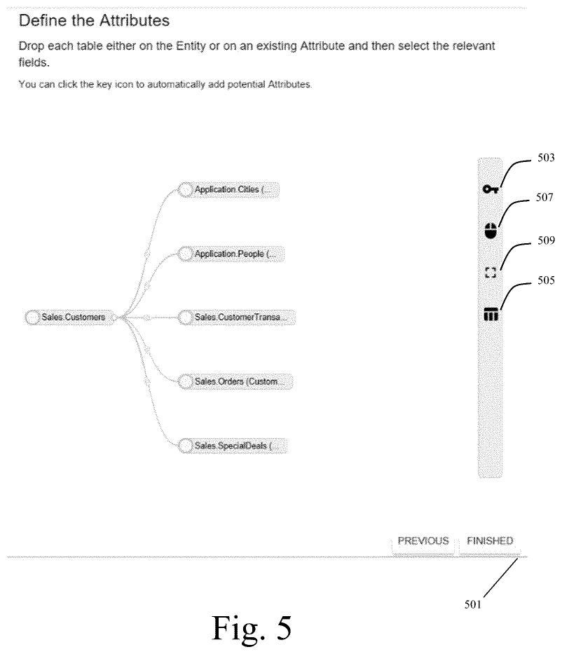

Turning to FIG. 5, shown is an example UI screen 501 which allows the user to select “attributes” of the entity. The functionality discussed herein in connection with FIG. 5 can be performed by the attributes selection module 111. The attributes can correspond to features which are provided to the MLM during training of the MLM, and when asking the MLM to make predictions. As a high level example, suppose that the entity were customers, and that the MLM was to predict, based on inputs, whether or not a given customer would churn. In this high-level example, the attributes/features might be residence cities and income levels of customers. As such, in this high-level example, when predicting whether or not a given customer would churn, the MLM could take as inputs indication of the residence city and income level of the customer (e.g., encoded as one or more vectors). Subsequently, the MLM could output a prediction as to whether or not the given customer would churn. Further according to this high-level example, during training, the MLM could receive one or more training sets. Each element of the training set could include: 1) as training data inputs, indication of the residence city and income level of the customer; and 2) as training data outputs, data indicative of whether or not the customer had churned. According to various embodiments, where the user selects custom prediction 213, the user can specify one or more SQL queries which regard attributes chosen by the user.

Returning to the UI of FIG. 5, shown in the figure are icons including a key icon 503. By clicking on the key icon 503, the user can request that the system suggest attributes for selection by the user. As noted, when identifying the unique identifier of the entity, the user specified a primary key and table(s) corresponding to that unique identifier. In generating the suggested attributes, the system can examine these table(s), and find some or all foreign keys associated with the primary key therein. Next, the system can follow those foreign keys to their respective tables. In each respective table, the system can find some or all primary (and otherwise non-foreign) keys associated with the found foreign keys. Subsequently, the system can suggest as possible attributes for the MLM those primary (and otherwise non-foreign) keys. By selecting a key as an attribute, the user indicates that the system should use data accessible by that key as features for the MLM. It is noted that, in following the foreign keys to their respective tables, the system can follow the foreign keys to the tables in which they exist as non-foreign keys.

Also, the system can proceed in this fashion one or more levels deeper in a recursive fashion. As such, when following the foreign keys to their respective tables as discussed, the system can look for foreign keys in these tables. The system can then follow these deeper foreign keys to their respective deeper tables and act in a manner analogous to that discussed, including suggesting columns which correspond to found keys as possible attributes for the MLM. In some embodiments, the user can select the desired number of levels to which the system should recurse in this way.

Further still, the system can also suggest as attributes for the MLM the keys associated with the user-specified primary key in the table(s) which hold that primary key. Also, in some embodiments, the system can suggest keys/columns as possible attributes for the MLM by presenting, on the UI of FIG. 5, UI elements corresponding to the table(s) which hold those keys. In these embodiments, by clicking on a UI element for a table, the user can be presented with a list of the keys of the corresponding table, where each element of the list has a corresponding UI checkbox element. In some embodiments, the system can pre-select (i.e., set the corresponding UI checkbox element to selected/“yes”) those keys/columns of the table that the system is suggesting as attributes. The user can then accept the pre-selections of keys by the system, de-select one or more of the keys pre-selected by the system, and/or select additional keys.

Also, according to various embodiments the system can employ an LLM (e.g., a chat-based LLM) to generate attribute suggestions. Such functionality can be provided via the LLM module 115. As just an illustration, a prompt engineering approach can be employed. Here, the system can use a prompt that specifies one or more at-hand keys/columns (and/or tables), and also a desired prediction type/use case. More specifically, the prompt can include first interrogatory text (e.g., “Which of the following database keys/columns and tables: \n”) along with indication of one or more keys/columns and tables. The prompt can further include second interrogatory text (e.g., “\n are likely to hold data relevant for a machine learning model to generate predictions for the prediction types/use case of \n”) along with indication of a prediction type/use case (e.g., “fraud detection”). In various embodiments, the system can sample data from the indicated keys/columns (and/or tables). In these embodiments, the system can include the sample in the prompt along with a request that the LLM take the sample into account when determining which keys/columns (and/or tables) are likely to hold relevant data. In return, the system can receive from the LLM a completion specifying keys/columns (and/or tables) of the prompt that the LLM considers relevant. Subsequently, the system can suggest these keys/columns (and/or tables) as attributes. The LLM can also generate SQL code that allows the relevant keys/columns (and/or tables) to be accessed (e.g., for formulation of a training set).

Also, in some embodiments, the user can be presented with a UI element allowing for selection/deselection of all keys of the table. Subsequent to completing his/her selections, the user can press a “done” UI button element, causing the system to use the selected keys(s)/column(s) as attributes for the MLM. The UI elements for tables can, in some embodiments, be presented in a tree-like diagram. Each node of the tree can be one of the noted UI elements for tables. By clicking on a node/table, the user can indicate which columns of that table are going to be used as attributes. Further in this tree-like diagram, tables can be connected by lines which represent joins between the tables. By clicking on a line, the user can alter the composition of the join in a manner analogous to that discussed. In some embodiments, the joins can be pre-composed by the system, such that clicking on a line allows the user to see and/or alter the pre-composed join. As an illustration, such a pre-composed join can be an equality-condition join between a primary key of a first table and a corresponding foreign key of a second table, with the system having automatically determined the primary key-foreign key relationship (e.g., due to key name similarity, for instance key “DeliveryCityID” in the first table as being similar in name to key “CityID” in a second table). In some embodiments, the composition of the join—such as the keys indicated in the join and the type of join (e.g., left vs. right vs. inner)—can dictate which keys are presented to the user for selection as attributes, as discussed.

Additionally, in various embodiments the user can drag tables to the UI, or select tables via a UI frame which is exposed subsequent to the user clicking a table icon 505 of the UI of FIG. 5. Next, the user can connect the tables via user-defined joins and select one or more keys of the tables as attributes. In this way, the user can manually choose tables, and select keys thereof to be used as attributes. Additionally, the user can zoom and pan along the tree-like diagram, using the UI. In some embodiments, the user can click on a mouse icon 507 of FIG. 5 to enter a mode in which the user can perform such zoom and pan. Further, the user can enter a full screen mode for viewing the tree-like diagram. In some embodiments, the user can click on a reticle icon 509 of FIG. 5 to enter such a full screen mode.

Subsequent to completing selection of attributes via the UI of FIG. 5, the user can be prompted to provide, via a UI text field element, a name for the prediction task which the user has configured via the actions discussed in connection with FIGS. 2-5. After providing a name for the prediction task, the user can be presented with a UI button which allows the user to request that the system train the MLM. Upon the user selecting this button, the system can commence training of the MLM. As such, the system can provide the MLM with a training set. Each member of the training set can correspond to a given entity (e.g., a given customer) for which data is held in the data source which was specified by the user. Further, each member of the training set can include, as training data inputs, features for the given entity which correspond to the attributes selected by the user. As an illustration, where “Customer.ResidenceCity” was selected by the user as an attribute, the features for the given entity could include the data held in the data source (or calculated on-the-fly by the system) for the given entity for Customer.ResidenceCity. Also, each member of the training data set can include, as training data output, data for the given entity which corresponds to the target selected by the user.

As an illustration, where “Sales.Orders.OrderShipped” was selected by the user for the target, the training data output for the given entity could include the data held in the data source (or calculated on-the-fly by the system) for the given entity for Sales.Orders.OrderShipped. In some embodiments, the system can split such data for entities into a both a training set and a test set. The training set could be as discussed, and correspond to certain entities (e.g., certain customers) for which the data source holds data. The training set can be used to train the MLM, as discussed. The test set could correspond to others of the entities (e.g., other customers) for which the data source holds data. Each element of the test set can be similar in composition to the discussed training set elements. However, instead of using the features for the given entity as training data inputs, these features can be fed to the MLM, and the MLM can then generate a prediction output based on the features. The generated output can then be compared to that which the data source holds for the given entity for the target specified by the user. As an illustration, where “Sales.Orders.OrderShipped” was selected by the user for the target, the system could compare the data held in the data source for the given entity under Sales.Orders.OrderShipped to the output of the MLM. By acting in this way for each given entity of the test set, the system can create various statistics characterizing how well the predictions of the MLM track ground truth according to the data source. Additionally and/or alternatively, the system can split such data for entities according to time. In this embodiment, the more recent information can be used in the test set. The discussed operations regarding training and testing the MLM can be performed by the MLM module 113.

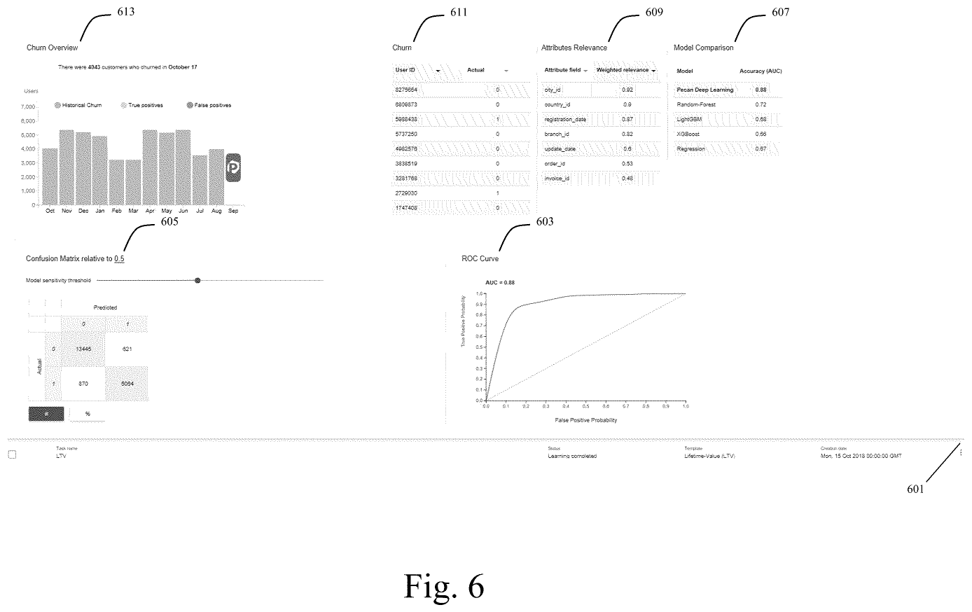

Turning to FIG. 6, shown is a UI screen 601 by which the user can view various characterizations of the quality of the predictions generated by the MLM. The functionality discussed herein in connection with FIG. 6 can be performed by the MLM module 113. The characterizations can reflect the discussed test set operations. As depicted by FIG. 6, these characterizations can include indications of true positives and false positives, such as receiver operating characteristic (ROC) curves 603 and confusion matrices 605. As also depicted by FIG. 6, the UI can present information 607 characterizing how well the MLM of the system is making predictions versus other models (e.g., regression models). In order to present such information, the system can firstly train each of the other models using the training set discussed above. Next, the system can, in manner analogous to that discussed, use the test set to characterize prediction quality of each of these other models. Then, by comparing the prediction quality of each of these other models to the MLM of the system, the system can generate the noted characterizing how well the MLM of the system is making predictions versus other models. As also depicted by FIG. 6, the UI can provide indication 609 of the relevance of each of the attributes. The system can generate these indications of relevance by performing a statistical analysis which determines the extent to which variance in a given attribute, when provided to the MLM as a feature, leads to variance in MLM output. Also, in various embodiments, the UI can provide indication of the influence/effect of each of the attributes. As such, in various embodiments the UI can provide one or more Partial Dependence Plots (PDPs), Shapley values, and/or Shapley Additive exPlanations (SHAPs). For instance, the UI can display one or more SHAP summary plots, SHAP feature relevance plots, and/or SHAP dependence plots. Then, as additionally depicted by FIG. 6, the UI can provide per-entity indication 611 of observed/historical data (according to the example of FIG. 6, providing per-user/customer ID indication of presence or absence of observed/historical churn), and overview information 613 which can include co-plotting of observed/historical data, true positives, and false positives.

According to various embodiments, the system can employ an LLM (e.g., a chat-based LLM) to explain data science concepts (e.g., key data science concepts) to the user. Such functionality can be provided via the LLM module 115. For example, a prompt engineering approach can be used where the LLM is provided with a prompt that includes a block of text that explains various data science concepts. The prompt can also include data that pertains to an at-hand model (e.g., the type of model and/or the type of prediction being made by the model). The approach can further include instructing the LLM that it answer, based on the provided block of text and the data, data science questions posed by the user. In this way, the system can receive (e.g., via a UI) one or more data science questions posed by a user, and generate, using the LLM, one or more answers to the one or more questions. As such, via the functionality just described the LLM can give straightforward explanations of data science concepts that can assist the user in understanding and/or evaluating model performance.

Also, according to various embodiments the system can employ an LLM (e.g., a chat-based LLM) to provide recommendations for improving model performance. Such functionality can be provided via the LLM module 115. As an illustration, a prompt engineering approach can be used where the LLM is provided with a prompt that includes a block of text that lists various model performance issues along with corresponding solutions. The prompt can also include data that pertains to an at-hand model (e.g., current performance of the model, and/or other metrics calculated by the system for the model). The approach can further include instructing the LLM that it offer, based on the provided block of text and the data, suggestions for enhancing model performance.

As one example, the user can indicate (e.g., via a UI) one or more model performance problems to the LLM. Alternately or additionally, as another example the system can recognize one or more model performance problems, such as by determining that one or more performance metrics fall beneath one or more thresholds, and then can pass indication of these problems to the LLM. In return to the user or system input, the LLM can provide one or more solutions. As such, via the functionality just described the LLM can provide recommendations for improving model performance.

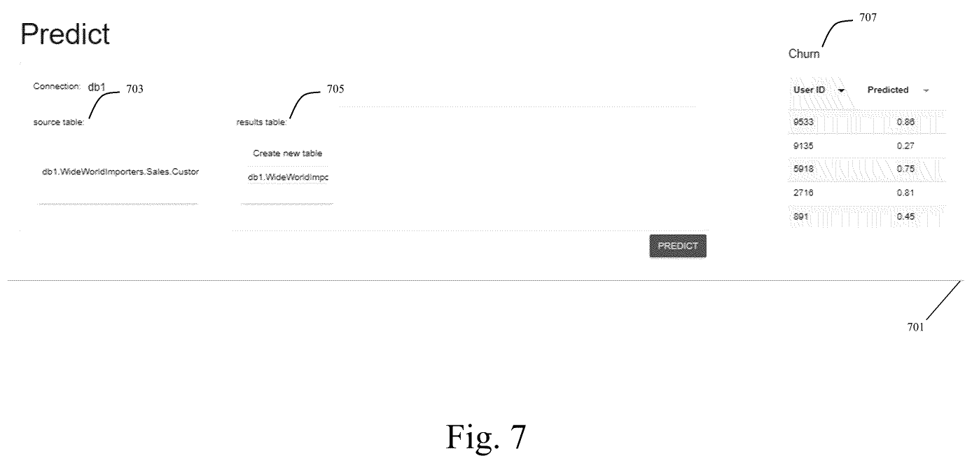

Turning to FIG. 7, shown is a UI screen 701 by which the user can request that the MLM generate predictions. The functionality discussed herein in connection with FIG. 7 can be performed by the MLM module 113. When requesting that predictions be made, the user can use the UI to: 1) select (703) an input data source and/or a table which holds data to be inputted to the MLM; and/or 2) select (705) an output data source and/or a table into which predictions output by the MLM can be recorded. Subsequently, for some or all of those entities (e.g., customers) for which data is held in the input data source and/or table, the system can draw data which corresponds to the attributes specified by the user. Alternately or additionally, the system can calculate on-the-fly data which corresponds to various attributes specified by the user (e.g., where one or more attributes specified by the use correspond to generated columns). For each such entity, this data can be provided as input features to the MLM, and in response the MLM can generate a prediction (i.e., a prediction corresponding to the target specified by the user). Then, the system can record the output of the MLM in the output data source and/or table. In this way, the system can use the MLM to generate a prediction for some or all of the particular entities for which the input data source and/or table holds data. In some embodiments, as an alternative or in addition to recording the predictions output by the MLM in the output data source and/or table, the system can present (707) one of more of these predictions to the user via the UI of FIG. 7. For example, the system can present a table on the UI which lists the unique identifier of each entity for which the MLM made a prediction, and also the value which the MLM predicted for that entity (i.e., a predicted value corresponding to the target).

In some embodiments, the system can formulate various data source queries, such as SQL queries. Such formulation can be performed by the MLM module 113. In particular, the system can formulate: 1) queries which yield from the data source data corresponding to the user's indication of entity; 2) queries which yield from the data source data indicated by the user as attributes; and/or 3) queries which yield from the data source data indicated by the user for the target. In various embodiments, such indications from the user can be stored by the system in one or more objects (e.g., one or more JavaScript Object Notation (JSON) objects). Subsequently, the system can process these one or more objects in formulating the queries.

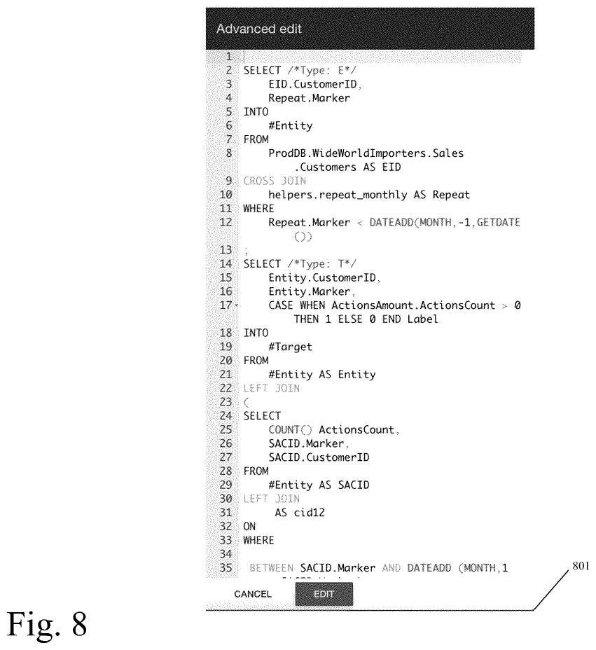

As an illustration, where the user indicated that Residents.YearsOld and RecreationSection.FavoriteSport should be used as attributes, the system can generate one or more queries which draw data from the columns specified by Residents.YearsOld and RecreationSection.FavoriteSport. As another illustration, where the user indicated that Residents.TerminatedLease should be used for target, the system can generate one or more queries which draw data from the column specified by Residents.TerminatedLease. In some embodiments, the queries generated by the system can include join queries. Further, in some embodiments the system can allow the user to view and/or edit the queries which have been generated by the system. For example, included on the entity UI screen discussed in connection with FIG. 3 can be a UI button which allows the user to view and/or edit the queries (e.g., SQL queries) that the system has generated responsive to the user's inputs regarding entity. In this regard, shown in FIG. 8 is an example UI screen 801 presented to the user for viewing and/or editing such system-generated queries. As another example, included on the entity UI screen discussed in connection with FIG. 4A can be a UI button which allows the user to view and/or edit the queries that the system has generated responsive to the user's inputs regarding target.

Likewise, as a further example, included on the entity UI screen discussed in connection with FIG. 5 can be a UI button which allows the user to view and/or edit the queries that the system has generated responsive to the user's inputs regarding attributes. As yet another example, included on a UI screen which allows the user to provide a prediction task name can be a UI button which allows the user to view and/or edit all of the queries which the system has generated (e.g., both queries relating to target and queries relating to attributes). It is further noted that, in various embodiments, the system can formulate various data source queries in connection with performing on-the-fly calculations for generated columns. For instance, where such an on-the-fly calculation operates on values held in the data store, the system can generate one or more queries which draw such values from appropriate columns of the data store. In various embodiments, the system can employ referential dynamic code components in formulating data source queries. As an example, the discussed functionality by which the system formulates data source queries can be termed “template SQL (TQL).”

The system can generate database queries for a wide variety of purposes. As just an illustration, the system can generate database queries in connection with preparing training sets. In some embodiments, the system can use SQL templates in generating queries. In other embodiments, the system can use (e.g., in connection with the LLM module 115) an LLM (e.g., a chat-based LLM) in generating queries.

Where an LLM is used in generating queries, as just an illustration suppose that the system is to select a CustomerID column in a table People. Here, prompt engineering approaches can be employed that involve passing to the LLM a prompt that, continuing with the illustration includes “generate SQL code to select a ‘CustomerID’ column in a table ‘People’.” Continuing further with the illustration, the system can subsequently utilize the SQL code generated by the LLM in performing a database access.

As another illustration where an LLM is used in generating queries, suppose that the system is to perform an inner join query between a table Orders and a table Customers, with respect to a column CustomerID. Here, prompt engineering approaches can be employed that involve passing to the LLM a prompt that, continuing with the illustration includes “for a table ‘Orders’ and a table ‘Customers,’ generate an SQL inner join query over a common column ‘CustomerID’.” Continuing further with the illustration, the system can subsequently utilize the SQL code generated by the LLM in performing a database access. It is noted that using LLMs in generating queries can yield benefits including significantly enhancing query validity and accuracy, and increasing the complexity of the prediction types/use-cases that can be supported.

As an additional illustration where an LLM is used in generating queries, a prompt engineering approach can be employed to have an LLM understand what model the user is trying to build, and what transformations the data needs to go through in order to become a valid training set. In this way, queries that are generated by the LLM can be tailored to the data and/or model of the user. According to the prompt engineering approach, the system can use a prompt that specifies database keys/columns that have been determined (e.g., determined by the LLM as discussed herein) to hold data relevant for an at-hand prediction type/use case. The prompt can further include a request that the LLM transform the data of the keys/columns into a training data set. In various embodiments the prompt can also include an indication of model type and/or an indication of prediction type/use case.

More specifically, as just an illustration the prompt can include first interrogatory text (e.g., “For database key(s)/column(s) that contain machine learning model inputs: \n”) along with indication of one or more keys/columns that contain machine learning model inputs. The prompt can further include second integratory text (e.g., “\n and for database keys(s)/column(s) that contain ground truth outputs: \n”) along with indication of one or more keys/columns that include that contain ground truth outputs. The prompt can also include third interrogatory text requesting that the LLM extract and transform the data into a training data set (e.g., “\n generate code to extract and transform that input data and that ground truth data into a training data set”).

In various embodiments, a prompt can be passed to the LLM that contains instructions on how to transform the relevant data into a training set. In response to the prompt, the LLM can perform various transformation operations. It is noted that the LLM can generate SQL queries in response to the prompt. The prompt can be long and complex (e.g., dozens of pages in length). In some embodiments, the prompt can be formulated via an iterative process (e.g., an automated process involving a second LLM). According to the iterative process, proposed prompts (or prompt portions) that contain data transformation instructions can be passed to the LLM, the actions taken by the LLM can be noted, and the prompt (or prompt portions) can be revised in consideration of the actions.

The long and complex prompt can, as just some examples, instruct the LLM in: a) data scanning (e.g., scanning for various patterns, such as character, word, and/or value sequences); b) data profiling; c) data mapping; d) data normalization; e) data splitting; f) data aggregation (e.g., data joining); g) removing unwanted data; h) data filtering; i) data cleansing; j) data deduplication; k) data enrichment; l) data structuring; m) data conversion; n) data updating (e.g., with respect to one or more further data sources); and/or o) data anonymization. In reply to one or more of the discussed prompts, the LLM can perform various operations (e.g., transformation operations) so as to create a training set. As just some examples, the LLM can generate (e.g., along with code explanations) SQL and/or Python code (or other code) that performs these operations.

In various embodiments, the system can perform one or more past horizon operations when selecting attribute data to be included in training sets, to be included in test sets, and/or to be provided to the MLM when generating predictions. Such past horizon operations can be performed by the MLM module 113. In some embodiments, in implementing past horizon operations, the system can distinguish between two types of attributes—static attributes, and time-dependent/dynamic attributes. Static attributes can be the variables that are “stationary,” that is to say variables which do not alter with time (e.g., gender, date of birth, demographic info etc.). Dynamic attributes can be variables that are time-dependent, meaning that, at a certain frequency additional data can be added to a given column for a given entity. As an illustration, where a column corresponds to purchases by a given entity (e.g., a given customer), data can be added to the column each time a purchase is made. As such, for a given entity, there can be much data corresponding to dynamic attributes (e.g., data corresponding to many purchases). This large amount of data can present a challenge in determining how much of this data should be provided to the MLM. Said differently, a certain depth of historical data can be associated with the table(s) and key which correspond to each of the particular attributes selected by the user. As an illustration, where the user has selected an attribute corresponding to Sales.TransactionDate, for each given entity (e.g., customer) there can be a multitude of data listed for Sales.TransactionDate, for instance several months or years of transaction dates where the given entity has made a multitude of purchases over an extended period of time. In selecting how much of such a depth of historical data to include in a training set, a test set, and/or data to be provided to the MLM when generating predictions, the system can employ one or more approaches.

According to one such approach, the system can extract several alternative amounts of historical records (e.g., 5, 10, 20, 50, 100), and build a model separately for each (akin to grid search). As another example, the system can aggregate the historical dynamic attributes/data to various statistical representations (e.g., mean, median, mode, standard deviation, etc.)—based on three types of categorical variables. The three types of categorical variables can include: i) categorical variables that are another column in the table of interest; ii) categorical variables that are in intermediate tables (the group-by variables); and iii) categorical variables that are that are static. In this regard, the noted intermediate tables can be tables that are between a given table and a table which holds a unique identifier for the entity. As yet another example, the system can employ various machine learning approaches applicable to analyzing length-varying variables over a certain dimension (e.g., time). As illustrations, such machine learning approaches can include Long Term Short Memory (LSTM) recurrent neural networks and convolutional networks. Further, in some embodiments, autoencoders can be employed (e.g., in view of the ability of autoencoders to reduce feature dimensionality/compress inputs).

As an illustration of handling past horizon, the system can first determine the quantity-wise statistical distribution of the data among the plurality of entities (e.g., customers) to be considered by the system. For instance, where the system is considering how much of the noted Sales.TransactionDate data to use, the system can determine the statistical distribution describing how many elements of Sales.TransactionDate data there are for each of the entities (e.g., customers).

Next, the system can determine one or more descriptors of this statistical distribution, for instance mean, median, mode and/or nth quantile (e.g., 0.6 quantile, and/or 0.7 quantile). As an illustration for the noted Sales.TransactionDate data, the system might determine the mean to be 23 elements of Sales.TransactionDate per customer, and the 0.6 quantile to be 18 elements of Sales.TransactionDate per customer. Next, the system can run one or more tests wherein the system attempts training and testing according to several of the determined descriptors, and ascertains which descriptor yields the most satisfactory predictions (e.g., the most accurate predictions, or the most accurate predictions normalized for data processing cost, such as in terms of CPU time and/or database activity).

As an illustration for the noted Sales.TransactionDate data, the system might attempt training using the mean number of Sales.TransactionDate data elements per entity (e.g., 23 data elements) and also using the 0.6 quantile number of such data elements (e.g., 18 data elements). After this, the system can determine which of the mean number of data elements and the 0.6 quantile number of data elements provided the most satisfactory predictions. After determining which of such determined descriptors provided the most satisfactory predictions, the system could use this determined descriptor for production purposes when training, testing, and/or predicting. As an illustration, for the noted Sales.TransactionDate data, the system might find that using the 0.6 quantile number of data elements provided the most satisfactory predictions, and the system might select for such production purposes the most recent 18 data elements from the Sales.TransactionDate data, as 18 is the 0.6 quantile number of data elements according to the illustration.

According to another illustration of handling past horizon and selecting how much depth of historical data to include for a given attribute when training, testing, and/or predicting, the system can use a time-delimited approach in which the system chooses those data elements, for the given attribute, which have occurred during a historical period which is h times longer than a period p for which the MLM is to generate predictions. As an illustration, where h is 3 and p is one month (e.g., where the MLM is to predict churn one month ahead), the system can choose those data elements, for the given attribute, which occurred during the previous three months. Moreover, as a further illustration of handling past horizon, the system can alternate among multiple approaches for selecting how much depth of historical data to include for a given attribute when training, testing, and/or predicting, or perform testing between the multiple approaches, and choose for production the approach which provides the most satisfactory predictions (e.g., in a manner analogous to that discussed hereinabove for testing and determination of extent to which prediction is satisfactory).

Moreover, in various embodiments the system can perform three-dimensional to two-dimensional data structure transformations (e.g., via pivoting and/or flattening) when selecting attribute data to be included in training sets, to be included in test sets, and/or to be provided to the MLM when generating predictions. Such operations can be performed by the MLM module 113. As an illustration, three-dimensional data can exist for an attribute corresponding to Sales.TransactionDate where a given entity has made multiple purchases. In this illustration, the system can generate a two-dimensional data structure (e.g., a two-dimensional array) which contains plural data items drawn from Sales.TransactionDate for the entity.

It is noted that, in various embodiments, in connection with preparing training sets and/or test sets—and/or in connection with requesting that the MLM generate predictions—the system can convert data retrieved from the data source into a different format, for instance into an array-based format and/or a sparse matrix-based format. It is also noted that, in various embodiments, in connection with preparing training sets and/or test sets—and/or in connection with requesting that the MLM generate predictions—the system can apply one or more feature engineering and/or data encoding approaches. For instance, the system can apply a Principal Component Analysis approach (PCA) or an autoencoder approach so as to reduce the quantity of features that are passed to the MLM. As an illustration, according to such an approach the system can generate k output features from p input features, where k<p, and where the p input features correspond to the selected attributes. As a further example, the feature engineering/data encoding approaches can include the use of categorical embeddings (e.g., skip-gram and/or continuous bag of words (CBOW)-based neural embedding approaches) and/or one-hot encoding.

Further, in various embodiments, the system can perform one or more data leakage prevention operations with regard to attributes whose corresponding values are fed to the MLM (e.g., in connection with training and/or prediction). Such data leakage prevention operations can be performed by the MLM module 113. In an aspect, the data leakage prevention operations can act to avoid training the MLM using values of attributes which may not be available to the MLM at prediction time. As an illustration of such attributes, suppose that the MLM was to make NBO predictions regarding other products to be purchased by a customer who orders a first item, and that this prediction was to be made at or shortly after the customer placed an order for the first item. In this illustration, an attribute regarding whether or not the customer ultimately determined to return the item (e.g., within a merchant's window for doing so) could correspond to feature data not available to the MLM at prediction time (e.g., because the window corresponds to a time which is future to ordering time). The system can implement data leakage prevention operations in a number of ways.

For example, time markers can be used for preventing data leakage. Such a time marker can, for instance, represent the last moment in time for which a prediction can/will be made. As such, any data that is inserted into the data source after the time marker can be ignored by the system in order to prevent data leakage. As another example, to prevent data leakage, the system can obtain several snapshots of the data source (e.g., tables thereof) at different points in time. Then, the system can test whether there are significant (e.g., more than marginal error of X %) differences in the data held by given columns between snapshots (e.g., the data held in a certain column for a given entity changing significantly between a first and a second snapshot). Where the system detects such a significant change for a particular column for a given entity, the system can conclude that the column has been updated (e.g., after being initially computed). Where the system concludes a column to have been updated in this way, the system can opt to not utilize data from this column when providing inputs to the MLM. In this way, the system can act to prevent data leakage.

In various embodiments, time marker functionality can distinguish between event-driven/momentary predictions (e.g., predicting lifetime value at the moment of the user's registration) and repeated predictions (e.g., predicting whether a user would churn, every week on Sunday morning). For the former, the time marker can be the event that would trigger the prediction. For the latter, the system can create a compound entity, comprising the original entity, multiplied by each periodic time point—the frequency of which (time stride) is determined by the user, or according to the expected prediction frequency. For example, where the system is to predict churn each Sunday, the system can take the entity (e.g., customer), and cross join it with all the historical relevant Sundays in the data source. For each of these compound entities, the system can create a separate data point for the MLM. The periodic time-points can serve as the time markers for each compound entity, respectively.

With further regard to prevention of data leakage, in various embodiments data held in the data store can be date stamped. As such, where the system finds that a date stamp associated with data held with respect to a potential attribute was future to an intended prediction time, the system can determine that such an attribute not be utilized for training and/or prediction. As examples, where the system determines that a given attribute not be utilized the system can: a) not include the attribute when recommending attributes to the user; and/or b) in the case where the user suggests use of the attribute, advise (e.g., via a UI message) the user against using the attribute. Returning to the illustration, the system might find a timestamp associated with data indicating whether or not the customer returned the item was future to the intended prediction time of at or shortly after the item being ordered. As such, the system might determine that such an attribute regarding item return not be utilized for training and/or prediction.

Moreover, in various embodiments the system can perform one or more of: a) hyperparameter selection operations; b) data normalization operations; c) handling of missing and/or broken values of attributes; d) detecting incorrect data types and/or improper use of columns; e) detecting data referencing errors and/or inadequacies; f) determining data insufficiency (e.g., insufficient data rows and/or data features); and g) detecting overfitting. Such operations can be performed by the MLM module 113. Turning to hyperparameter selection operations, the system can, as examples, utilize random search and/or grid search in selecting hyperparameters. The hyperparameters which the system selects can include both optimizer hyperparameters and MLM hyperparameters. As illustrations, the hyperparameters which the system selects can include quantity of layers, quantity of neurons for each layer, and learning rate, to name just a few. It is noted that the MLM discussed hereinthroughout can be a classifier MLM, a random forest MLM, or a neural network MLM (e.g., a multilayer perceptron neural network), to name just a few possibilities. Turning to data normalization operations, the system can, as examples, utilize Z-score normalization, point relative normalization, and/or maximum/minimum normalization in normalizing values for attributes among given entities (e.g., among customers).

Turning to handling of missing and/or broken values of attributes, the system can consider a value for a given attribute to be missing where the value is null or zero. Further, the system can consider a value to be “broken” where the value is out of place and/or unexpected. For instance, where the system finds the value for a given attribute of a given entity to differ greatly other values for the attribute from other entities (e.g., to differ by more than three standard deviations of a mean of such values), the system can consider the value to be broken. As an illustration, suppose that entities are customers and that a given attribute is total annual spending. In this illustration, where the average total annual spending across all customers is $600, where the value of this attribute were $2,000,000 for a given customer, this value could be considered to be “broken” by the system (e.g., due to $2,000,000 being more than three standard deviations away from $600). Where the system determines a given value to be missing or broken, the system can, in some embodiments, replace the value. As one example, the system can employ an imputation approach to generate an estimated reconstruction of the missing or broken value. Then, the system can replace the missing or broken value with the reconstruction. As one illustration, the imputation approach can employ a denoising autoencoder with partial loss (DAPL) or other autoencoder. As another example, the system can employ a PCA-based imputation approach. As another example, the system might replace the value with an average for the value among others of the relevant entities. Continuing with the illustration, the $2,000,000 value might be replaced with the average value of $600. Also, in some embodiments, where a given entity (e.g., a particular customer) has for one of the attributes a missing or broken value, the system might not use that given entity in training or prediction. For instance, where data for the given entity is part of a training set, the system might not use data of the entity in training the MLM. Likewise, where a prediction has been requested for the given entity, the system might not generate such a prediction. As such, the system might generate a UI message identifying the given entity (e.g., by customer number) and explaining that no prediction is being made for the given entity due to the missing or broken value. Further still, in various embodiments the system can determine whether there is an excessive quantity of nulls or zeros (e.g., whether the quantity exceeds a threshold). Also, in various embodiments the system can, as discussed above, perform data leakage prevention operations. Where an excessive quantity of nulls or zeros is found or data leakage risk is detected, the system can take action.

In particular, in various embodiments the system can employ an LLM (e.g., a chat-based LLM) to provide recommendations for handling an excessive quantity of nulls or zeroes (or for handling data leakage). Such functionality can be provided via the LLM module 115. As an illustration, a prompt engineering approach can be used where the LLM is provided with a prompt that includes a block of text that describes various symptoms of and/or solutions for an excessive quantity of nulls or zeros (or data leakage). The prompt can also include data that pertains to an at-hand training set (e.g., the prompt can include one or more portions of the training set). The prompt engineering approach can further include instructing the LLM that it offer, based on the provided block of text and the data, suggestions for handling the excessive quantity of nulls or zeros (or data leakage). The suggestions generated by the LLM can be presented to the user (e.g., via a UI).

Turning to detecting incorrect data types and/or improper use of columns, as one example the system can: a) access the schema information for one or more columns of a given table; b) access one or more cell values of those columns; c) ask the user for a description of the cell values; and d) determine, using an LLM (e.g., a chat-based LLM via the LLM module 115) whether the description provided by the user matches the corresponding schema information. As just an illustration, the prompt can include first interrogatory text (e.g., “Does the following description: \n”) along with indication of the description provided by the user. The prompt can further include second interrogatory text (e.g., “\n match the following schema: \n”) along with indication of the schema information. Where a mismatch is found (e.g., where the LLM completion indicates a mismatch), the system can take action (e.g., bringing the mismatch to the attention of the user via UI, and asking the user to perform correction). By the use of such functionality various benefits can accrue. As just an illustration, such functionality can allow the system to detect improper use of date columns (e.g., where a DATE data type has been specified for a given column, but one or more cells of that column contain values of types other than DATE).

Turning to detecting data referencing errors and/or inadequacies, as just an example the system can perform referential integrity confirmation operations. Here the system can perform actions such as confirming that a foreign key value exists in the primary key column of a second table that is referenced by a first table. As just another example, the system can perform normalization/redundancy reduction operations. Here the system can perform actions such as: a) detecting redundant data columns among multiple tables; b) where a set of redundant data columns is detected, reducing that set to a single data column in a single table; and c) establishing key references to that data column of the single table from the other tables of the set (e.g., establishing foreign key relationships). As just a further example, the system can perform table join error detection operations. Here the system can perform actions such as detecting that a referenced column does not exist in a specified table, and/or that columns to be joined have incompatible data types. Where the system detects a normalization/redundancy reduction issue, the system can take action (e.g., bringing the issue to the attention of the user via UI).

Turning to determination of data insufficiency, as just an example the system can ascertain whether available data rows and/or data features (e.g., data rows and/or data features to be used in training an MLM) fall beneath one or more thresholds (e.g., a one or more quantity and/or quality thresholds). As to detection of overfitting, as just an example the system can recognize that a given MLM performs well prediction wise when operating on training data, but performs poorly prediction wise when operating on other datasets (i.e., that the MLM is unable to generalize to other datasets). Where the system determines data insufficiency or detects overfitting, the system can take action. For example, as discussed above the system can use an LLM to explain data science concepts. In various embodiments, the system can use this functionality to aid the user in addressing detected data insufficiency (or overfitting). In particular, a prompt provided to the LLM can include: a) a block of text explaining data science concepts relating to data insufficiency (or overfitting); b) information corresponding to the detected data insufficiency (or overfitting); and c) a request that the LLM generate, based on the provided block of text and the provided information, recommendations for solving the data insufficiency (or overfitting). Subsequently, the recommendations (e.g., the top recommendations) generated by the LLM can be provided to the user (e.g., via a UI).

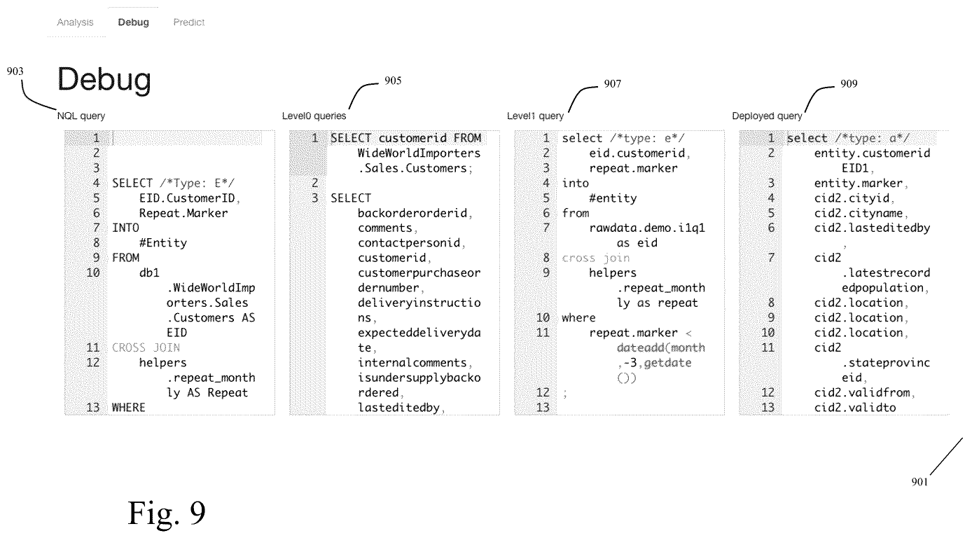

As referenced above, in various embodiments the system can formulate queries (e.g., SQL queries) to draw data from the data source. Shown in FIG. 9 is a UI screen 901 which allows the user to view and/or edit various such queries. In particular, depicted in FIG. 9 are four UI frames: a) an “NQL query” frame 903; b) a “Level0 queries” frame 905; c) a “level1 query” frame 907; and d) a “Deployed query” frame 909.

The NQL query frame 903 can contain code corresponding to queries generated by the system responsive to the user's inputs regarding entity and target. The Level0 queries frame 905 can contain code corresponding to queries generated by the system responsive to the user's inputs regarding attributes. The Level1 query frame 907 can contain code corresponding to system-generated queries which unify the queries of the NQL query and Level0 queries UI frames. The Level1 query frame can further contain code for creating indexes in the data source (e.g., clustered indexes) which correspond such unified queries. The Deployed query frame 909 can contain code like that of the Level1 query frame 907, but without the code for creating indices. As such, the code of the Deployed query frame 909 can, relative to the code of the Level1 query frame 907, allow for queries to be performed without the overhead of index creation. In some embodiments, the view/edit functionality of FIG. 9 can be provided via UI screen labeled “Debug” and/or accessed via a UI tab labeled “debug.”

In various embodiments, the system can use (e.g., in connection with the LLM module 115) LLM capabilities that allow the user to debug queries. Such capabilities can allow the user to: a) identify SQL code to the LLM (e.g., by selecting the code via a UI); b) describe to the LLM a problem (or problems) being experienced with the code; and c) receive from the LLM a suggested code edit (or edits) that address the problem (or problems). It is noted that hereinthroughout where the LLM generates code, in various embodiments also received from the LLM can be a discussion of the generated code. In these embodiments, included in a prompt passed to the LLM by the system can be text requesting such a discussion (e.g., the prompt can include the text “Explain the code that you generate”). Further, in various embodiments the system can use the LLM to provide discussion for code written by the user. In these embodiments, a prompt passed to the LLM can include integratory text (e.g., “Please explain the following code: \n”), followed by code written by the user.

Further, in various embodiments the system can use (e.g., in connection with the LLM module 115) LLM capabilities that allow the user to update queries and/or transform the training set. Such capabilities can allow the user to: a) identify SQL code (or other code) to the LLM (e.g., by selecting the code via a UI); b) describe to the LLM an update (or updates) to be made to the code; and c) receive from the LLM a suggested code edit (or edits) that implement the desired update (or updates).

As just an illustration, the code can generate an SQL inner join over a common column CustomerID, and the change description can be “please change the SQL code to instead do the inner join over common column ‘CityID’.” As just another illustration, the code can be SQL code that, in support of the system building a training set, accesses CustomerID data that is to act as a source of training data input (predictive input) values. Further according to the illustration, the change description can be “please change the SQL code to instead access ‘CountryID’ as a source of training data input (predictive input) values.”

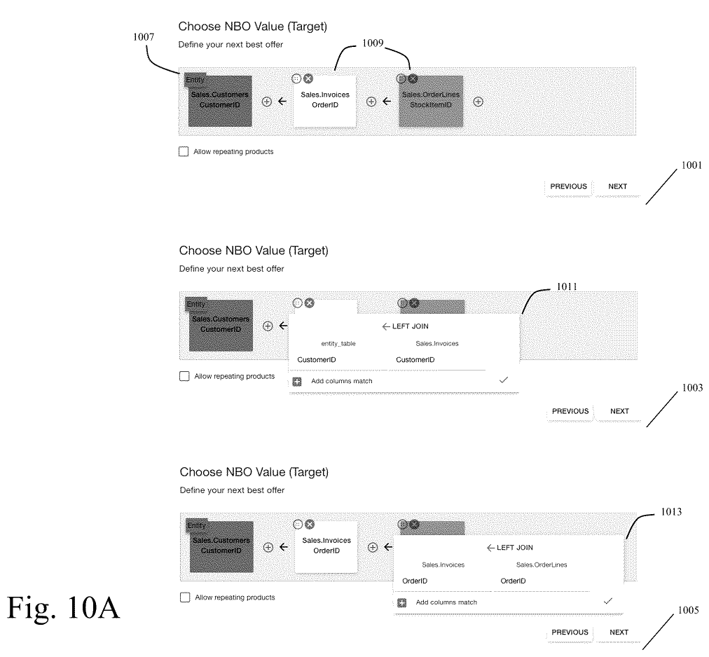

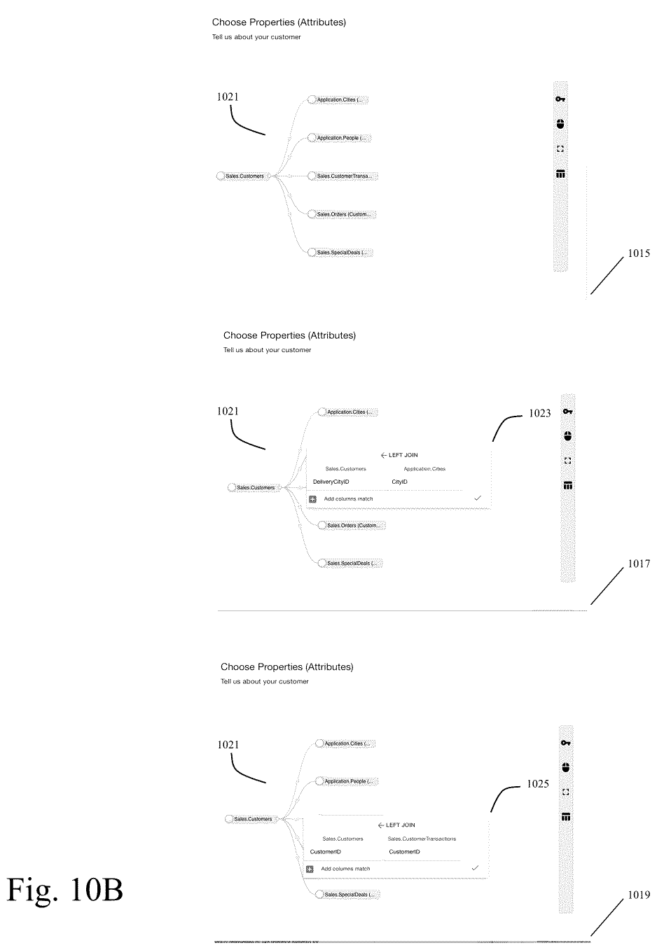

As referenced above, various joins can be formulated in connection with the functionality discussed herein. The system can use these joins to query the data source, and can further generate data structures which correspond to the results of the queries. Turning to FIG. 10A, shown are three UI screens 1001-1005 regarding selection of target. As depicted by the topmost UI screen 1001 of FIG. 10A, the user has: a) previously specified (1007) Sales.Customers.CustomerID in connection with entity; and b) specified (1009) Sales.Invoices.OrderID and SalesOrderLines.StockItemID in connection with target. In the middle UI screen 1003 of FIG. 10A, the system has requested (1011) that the user define a join between: a) the Sales.Customers table specified by the user in connection with entity; and b) the Sales.Invoices table specified by the user in connection with target. As shown by FIG. 10A, the user has specified a left join over Sales.Customers.CustomerID and Sales.Invoices.CustomerID. Then, in the bottommost UI screen 1005 of FIG. 10A, the system has requested (1013) that the user define a join between: a) the Sales.Invoices table specified by the user in connection with target; and b) the Sales.Orderlines table specified by the user in connection with target. As shown by the figure, the user has specified a left join over Sales.Invoices.OrderID and Sales.OrderLines.OrderID. The system can generate a data structure which combines the results of both joins. Alternately or additionally, the system can generate a data structure corresponding to the results of just the first join and/or a data structure corresponding to the results of just the second join.

Likewise, turning to FIG. 10B shown are three UI screens 1015-1019 regarding selection of attributes. As depicted by the topmost UI screen 1015 of FIG. 10B, the user has pressed the above-discussed key icon 503 and has received system-suggested attributes in reply via the displayed tree-like diagram. The tree-like diagram 1021 of FIG. 10B, as discussed above, depicts tables connected via lines, where the lines represent joins between the tables. As referenced above, by clicking on the lines the user can view and/or edit the joins. In the middle UI screen 1017 of FIG. 10B, the user has clicked on the line of the tree between the Sales.Customers table and the Application.Cities table. In reply, the user has learned (1023) that these two tables are presently subject to a system-generated left join over Sales.Customers.DeliveryCityID and Application.Cities.CityID. Then, in the bottommost UI screen 1019 of FIG. 10B, the user has clicked on the line of the tree between the Sales.Customers table and the Sales.CustomerTransactions table. In reply, the user can learn (1025) that these two tables are presently subject to a system-generated left join over Sales.Customers.CustomerID and Sales.CustomerTransactions.CustomerID. Likewise, by clicking on others of the lines of the tree the user can learn of the joins to which other tables depicted by the UI are subject. Akin to the functionality discussed in connection with FIG. 10A, the system can generate a data structure which combines the results of all of these joins, and/or can generate individual data structures corresponding to individual ones of the joins.

Various approaches can be used in deploying the trained MLM into a production environment. As one example, a real-time Application Program Interface (API)-based deployment approach can be used. According to this approach, the inference components of the MLM (e.g., the normalization, encoding, and/or feature engineering components) can be wrapped in a container (e.g., a Docker container) by the system. Subsequently, the container can be downloaded (e.g., by the user) and installed in the production environment. Further according to this approach, the MLM can be accessed (e.g., queried) through the API. In some embodiments, the API can be a Representation State Transfer (RESTful) API. As another example, an automatic data source update (e.g., database update)-based deployment approach can be used. According to this approach, the system can connect to the data source and update a table (e.g., a dedicated table) with predictions generated by the MLM. In some embodiments, these updates can be made according to a schedule.

Additionally and/or alternatively, the system can query external data and enrich a user's data for a more accurate prediction model. For example, external data can include holidays, special events, weather, financial data, and so on.

According to various embodiments, the system can use an LLM-based workflow chain (e.g., via an LLM orchestration framework such as LangChain) to automate the creation of predictive models. Such functionality can, for example, be provided by the LLM module 115. The chain can include multiple agent stages (e.g., stages as used in conjunction with LangChain or other LLM orchestration frameworks). A given agent of the chain can implement various functionality including prompt engineering-based functionality, tool use, and/or conventional code-based functionality. In various embodiments, the system can use the chain to interact with users via a conversational approach (e.g., a text-based and/or verbal conversational interface) that guides users step-by-step through the model-building process. Use of such a modular, agent-based architecture can yield benefits including enabling a clear separation of concerns and/or making complex processes manageable, transparent, and/or interactive.

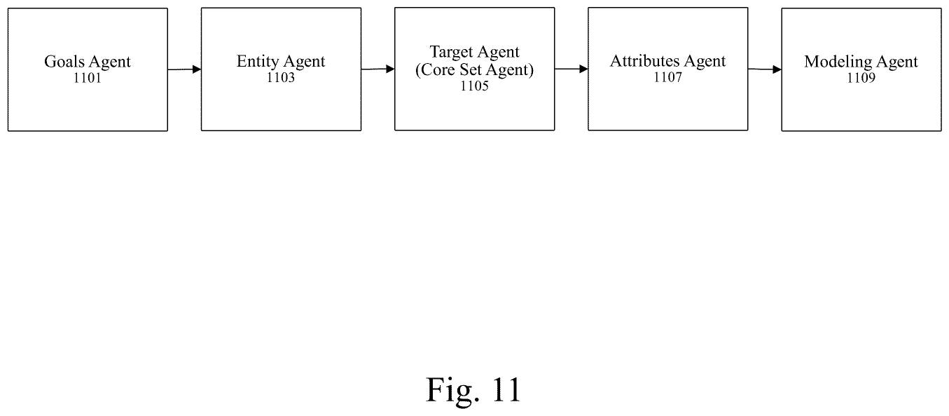

Turning to FIG. 11, in various embodiments the agents of the chain can include a goals agent 1101, an entity agent 1103, a target agent (core set agent) 1105, an attributes agent 1107, and/or a modeling agent 1109. A given agent of the chain can correspond to a certain model creation aspect, such as determining a predictive question or generating a training data set (e.g., a final training dataset). The agents 1101-1109 can, in various embodiments, operate sequentially, such as by way of agent-to-agent data flows. These agent-to-agent data flows can include passage of structured sets of model elements and/or datasets between agents, thereby, for example, supporting coherent and/or efficient operation. It is noted that, in various embodiments, one or more of the agents 1101-1109 can employ conversational approaches (e.g., text-based and/or verbal conversational interfaces) to interact with users when performing the operations discussed herein.

In employing the chain to automate the creation of a given predictive model, the system can begin by using the goals agent 1101. The goals agent 1101 can, use prompt engineering-based and/or conventional code-based functionality to translate an objective (e.g., a business objective) of a user into a formal, machine-readable predictive question. More specifically, the goals agent 1101 can generate a data structure that can be passed by the system to further agents of the chain. The data structure (e.g., a dictionary) can include information regarding: a) the entity for which predictions are to be made; b) the target that is to be predicted; c) the timing of the predictions; and/or d) entity filters for the predictions. The entity filters can include population filters that serve to refine the population for which predictions are made. The operations performed by the goals agent 1101 can include engaging the user in a dialogue (e.g., a structured dialogue) that elicits information that allows the goals agent 1101 to construct the data structure.

With regard to entity, engaging the user in the dialogue can include distilling various information received from the user into one or more entity types recognized by the system. These system-recognized entity types can, as just some examples, include users, customers, and/or devices. As to target, engaging the user in the dialogue can include condensing information received from the user into one or more target types recognized by the system. These system-recognized target types can, as just some examples, include make a purchase, total purchase amount, and/or target value. Here, the make a purchase target type can correspond to the use of classification models, while the total purchase amount and/or the total purchase amount target types can correspond to the use of regression models.

Concerning prediction timing, the goals agent 1101 can use the dialogue to determine for the prediction one or more timing types recognized by the system. The system-recognized timing types can include recurring predictions and/or event-based predictions. Where the goals agent 1101 determines the recurring predictions timing type, the module can use the dialogue to ascertain a corresponding a prediction frequency interval (e.g., a regular interval) such as daily, weekly, and/or monthly. Where the goals agent 1101 determines the event-based predictions timing type, the module can use the dialogue to ascertain a corresponding triggering event and/or action, such as a user signing up (e.g., signing up for a service). In various embodiments, determining a triggering event and/or action can include the goals agent 1101 determining a timing for making the prediction relative to the event and/or action.

With regard to entity filters (e.g., population filters), the goals agent 1101 can use the dialogue to determine for the prediction one or more filter types recognized by the system. The system-recognized filter types can include behavioral filters and/or attribute filters. Where the goals agent 1101 determines the behavioral filters entity filter type, the module can use the dialogue to ascertain one or more corresponding past actions (e.g., users who logged in during the previous 30 days). Where the goals agent 1101 determines the attribute filters entity filter type, the module can use the dialogue to ascertain one or more static characteristics, such as customers from a particular region (e.g., customers from Texas).

In various embodiments, after performing the discussed information gathering operations, the goals agent 1101 can first synthesize the details into a human-readable description such as a formal predictive question. For instance, the agent can generate a human-readable description such as “Predict weekly, for users who logged in in the last 30 days, whether they will make a purchase in the next 7 days.” The goals agent 1101 can present the human-readable description to the user, such as via a UI. Alternately or additionally, the agent can generate a summary (e.g., a structured summary) of various potential data elements for the data structure that is to be passed to further agents of the chain.

Where the goals agent 1101 receives confirmation (e.g., explicit confirmation) from the user of the presented human-readable description and/or the summary, the agent can formulate the corresponding data structure. The data structure (e.g., named model_elements) can, for example be a dictionary (e.g., a structured dictionary).

According to various embodiments, the prompt engineering-based functionality of the goals agent 1101 can include the agent accessing a document. The document can provide descriptions of: a) the entity types recognized by the system; b) the target types recognized by the system; c) the timing types recognized by the system; and/or d) the filter types recognized by the system. Further, in these embodiments the prompt engineering-based functionality of the goals agent 1101 can include the agent following instructions to engage in a dialogue with the user to, in view of the document, determine for the at hand prediction task one or more entities, targets, prediction timings, and/or entity filters, and details thereof.

After employing the goals agent 1101, the system can apply the entity agent 1103. The entity agent 1103 can use prompt engineering-based functionality, tools, and/or conventional code-based functionality to perform various actions. These actions can include receiving the data structure (e.g., named model_elements) produced by the goals agent 1101 and generating a data structure (e.g., a database table named sampled_entities) that can be passed by the system to further agents of the chain.

This generated data structure can include a dataset of entities (e.g., an initial dataset of entities) that is consistent with the information specified by the data structure received from the goals agent 1101. The generated data structure can, for example, contain entity IDs and corresponding dates for sampling. For example, the dataset of entities can satisfy filter criteria specified by the data structure received from the goals agent 1101. More specifically, the actions perform by the entity agent 1103 can include identifying and sampling relevant entities from the user's data sources across multiple time points, thereby preparing the population for model training.

In an aspect, the entity agent 1103 can perform data discovery and mapping. The entity agent 1103 can have access to tools including a list_connections_tool and a list_tables_tool. The agent can use the list_connections_tool to determine available databases and to connect to one or more of those databases. The agent can use the list_tables_tool to determine available tables within the databases and to connect to one or more of the tables. The entity agent 1103 can employ the tools in exploring the available tables and performing various table and column mappings. These mappings can include mappings that correspond to behavioral and/or attribute filters indicated by the data structure received from the goals agent 1101.

As an illustration, where the received data structure indicates the users entity type, the table and column mapping can include mapping to a customer_id and/or user_id column in a user_activity table. As another illustration, where the received data structure indicates Texas region customers as an attribute filter, the table and column mapping can include mapping to a city_name and/or state_name column in a user_activity table.

The data discovery and mapping can also include the entity agent 1103 validating data formats and/or assessing the feasibility of joining tables. The data format validation can include confirming that values conform to expected types (e.g., that values of a city_name column contain strings). The table join assessment can include the agent determining whether two tables to be joined share at least one column in common (e.g., both tables have a user_id column). Where two tables to be joined do not share a column in common (i.e., where joins are not possible), the agent can generate one or more bridge tables. Further, the entity agent 1103 can present the results of the discussed operations to the user for confirmation.

As just an example, the entity agent 1103 can use a prompt template that includes the following:

### System Message

You are a data discovery agent responsible for mapping the entity, behavioral filters, and attribute filters to the appropriate tables and columns in a user's database. You have access to the following tools:
list_connections_tool: Lists available database connections.
list_tables_tool: Lists tables in a selected database connection.

### User Prompt

You have received and/or have access to the following model elements for a predictive modeling task:
Entity: {entity_type} (e.g., user, customer, device)
Behavioral filter: {behavioral_filter}
Attribute filter: {attribute_filter}

Your task is to:
1) Use list_connections_tool to identify available database connections.
2) For each connection, use list_tables_tool to list the tables.
3) Explore the tables and columns to determine:
   a) Which table and column uniquely identify the entity ({entity_type}), such as a primary key (user_id, customer_id, etc.).
   b) Which tables and columns contain the data needed for the behavioral filter ({behavioral_filter}).
   c) Which tables and columns contain the data needed for the attribute filter ({attribute_filter}).
4) Validate that the relevant columns have the correct data formats (e.g., integer for IDs, date for activity, string for attributes).
5) Assess whether the tables can be joined directly using a common key (e.g., entity ID). If not, identify whether a bridge table is needed for joining.
6) Present a mapping plan to the user, specifying:
   a) The table and column for the entity identifier
   b) The tables and columns for each filter
   c) The join plan

For the entity agent prompt template examples discussed herein, in various embodiments: a) the prompt portions under the “System Message:” heading can be specified to the LLM via a data structure (e.g., a Python data structure) along with a designation of “role”: “system”; and b) the prompt portions under the “User Prompt:” heading can be specified to the LLM via a data structure along with a designation of “role”: “user.”

Further, in various embodiments the prompt template can include information—such as an example format structure—that instructs the agent as to a format to be used for the mapping plan that is presented to the user. With regard to the curly-brace delimited placeholders included in the above prompt template example, it is noted that these placeholders can, for instance, be dynamically populated through the action of code (e.g., Python code) associated with the entity agent 1103 that utilizes relevant information extracted from the data structure received from the goals agent 1101 (e.g., the model_elements structure). This code can be aware of the context that the agent is to use for a given conversation, and can use outputs from the previous agent to feed the context to subsequent agents.

Where recurring predictions are to be made, after performing the data discovery and mapping the entity agent 1103 can perform date sampling. This date sampling can include the agent accessing one or more of the tables identified by the data discovery and mapping operations. Where, for example, the data discovery and mapping operations include behavioral filter handling, one or more relevant activity date columns can be known to the agent. Where the relevant activity date columns are not already known to the agent, the agent can explore the relevant tables to identify these columns.

The desired sampling interval (e.g., monthly or weekly) can be known from the data structure (e.g., named model_elements) received from the goals agent 1101. The agent can use this interval to generate a set of sampling dates. These sampling dates can, in an aspect, serve as reference points (e.g., “as-of” dates) for constructing future training examples (e.g., time-aware training samples).

The approach by which the entity agent 1103 determines the range for these sampling dates can include querying (e.g., using the list_connections_tool and/or the list_tables_tool) the one or more relevant behavioral activity tables to determine the minimum and maximum activity dates present in the data. Using this range and/or the desired sampling interval, the agent can generate a sequence of sampling dates (e.g., every Monday within the determined range). These sampling dates can enable the system to create multiple temporal snapshots for the entity population, thereby, for example, supporting robust model training.

As just an example, the entity agent 1103 can use a prompt template that includes the following:

### System Message

You are a date sampling agent responsible for generating a set of sampling dates for recurring predictions. You can query the relevant behavioral activity tables to retrieve date information. You have access to the following tools:
list_connections_tool: Lists available database connections.
list_tables_tool: Lists tables in a selected database connection.

### User Prompt

You have received and/or have access to the following model elements for a predictive modeling task:
(Known from your data discovery and mapping operations) Behavioral activity table: {behavioral_table}
(Possibly known from your data discovery and mapping operations, or possibly not available) Activity date column: {activity_date_column}
(Known from received model_elements) Desired sampling interval: {sampling_interval} (e.g., weekly, monthly)

Your task is to:
1) If the activity date column is not specified, explore {behavioral_table} to identify the column that records activity dates.
2) Query the {behavioral_table} to determine the minimum and maximum activity dates.
3) Generate a series of sampling dates within this range, spaced according to the {sampling_interval} (e.g., every Monday).
4) Output the list of sampling dates to be used as “as-of” dates for building training examples.

Further, in various embodiments the prompt template can include information—such as an example format structure—that instructs the agent as to a format to be used for the list of sampling dates. With regard to the curly-brace delimited placeholders included in the above prompt template example, these placeholders can, for instance, be dynamically populated through the action of code (e.g., Python code) associated with the entity agent 1103 that: a) utilizes relevant information generated by earlier actions of the agent; and/or b) utilizes relevant information extracted from the data structure received from the goals agent 1101 (e.g., the model_elements structure). The functionality by which the agent performs the dynamic population can, for example, be performed in a manner analogous to that discussed above (e.g., the code can be aware of the context that the agent is to use for a given conversation, and can use outputs from the previous agent to feed the context to subsequent agents).

After performing the data discovery and mapping, the entity agent 1103 can perform entity sampling query generation. This query generation can include the agent constructing and/or executing a query (e.g., a SQL query). In particular, the query can identify entities that,, as of the dates of the discussed sampling dates, satisfy any relevant behavioral and/or attribute filters. The entity agent 1103 can, in various embodiments, leverage tools and/or prompt engineering-based functionality to generate and/or run this query. For example, the agent can use a tool that can run an SQL query and save the result (e.g., the agent can use a tool named run_query_and_save_result_tool).

The query constructed by the agent can be formulated to consider the relevant sampling dates. Further, the query can be constructed to, for a given date, look back over a specified time window (e.g., the previous 30 days) to determine which entities meet active criteria (e.g., active behavioral criteria). The query can return, for example, a set of (entity_id, sampling_date) pairs. The data structure (e.g., a database table named sampled_entities) generated by the entity agent 1103 can include indication of these pairs.

As just an example, the entity agent 1103 can use a prompt template that includes the following:

### System Message

You are an entity sampling agent responsible for generating and executing a query to identify entities that satisfy specified behavioral and attribute filters as of each sampling date. You have access to the following tool for executing SQL queries:
run_query_and_save_result_tool: Executes SQL queries and returns the result.

### User Prompt

You have received and/or have access to the following model elements for a predictive modeling task:
(Known from your data discovery and mapping operations) Entity table: {entity_table}
(Known from your data discovery and mapping operations) Entity identifier column: {entity_id_column}
(Known from received model_elements) Behavioral filter: {behavioral_filter}
(Known from received model_elements) Attribute filter: {attribute_filter}
(Known from your date sampling operations) Sampling dates: {sampling_dates}
(Known from received model_elements) Behavioral window: {behavioral_window} (e.g., 30 days)
(Known from your data discovery and mapping and/or date sampling operations) Activity date column: {activity_date_column}

Your task is to:
1) For each sampling date in {sampling_dates}, construct a SQL query that:
   a) Looks back over the {behavioral_window} prior to the sampling date using {activity_date_column};
   b) Applies the {behavioral_filter} and {attribute_filter} to identify eligible entities.
2) Use run_query_and_save_result_tool to execute the query for each sampling date.
3) Output the resulting (entity_id, sampling_date) pairs for all entities that meet the criteria.

Also, in various embodiments the prompt template can include information—such as an example format structure—that instructs the agent as to a format to be used for the outputted (entity_id, sampling_date) pairs.

Here also, with regard to the curly-brace delimited placeholders included in the above prompt template example, these placeholders can, for instance, be dynamically populated through the action of code (e.g., Python code) associated with the entity agent 1103 that: a) utilizes relevant information generated by earlier actions of the agent; and/or b) utilizes relevant information extracted from the data structure received from the goals agent 1101 (e.g., the model_elements structure). As above, the functionality by which the agent performs the dynamic population can, for example, be performed in a manner analogous to that discussed above (e.g., the code can be aware of the context that the agent is to use for a given conversation, and can use outputs from the previous agent to feed the context to subsequent agents).

After performing the entity sampling query generation, the entity agent 1103 can perform validation and handoff. This validation and handoff can include the agent performing validation operations (e.g., basic validation operations) on the data that is to be included in the data structure (e.g., database table named sampled_entities) that is output by the entity agent 1103. The data can include the discussed (entity_id, sampling_date) pairs.

The validation operations performed by the agent can include ensuring that the data of the outputted data structure is suitable for downstream processing. For example, the agent can check that the data of the outputted data structure contains a non-zero number of results. Once validation is complete, the agent can make the data structure available for passage by the system to further agents of the chain.

As just an example, the entity agent 1103 can use a prompt template that includes the following:

### System Message

You are a validation agent responsible for performing validation on a dataset of (entity_id, sampling_date) pairs and saving the validated dataset for downstream processing. You have access to the following tool for saving tables:
save_table_tool: Saves a dataset as a named table in the database.

### User Prompt

You have received and/or have access to:
(known from your entity sampling query generation operations) a dataset containing (entity_id, sampling_date) pairs:

Your task is to:
1) Validate that the dataset contains a non-zero number of rows.
2) Check for missing or null values in the entity_id and sampling_date columns, and remove any rows with such issues.
3) Save the validated dataset as a table named sampled_entities using save_table_tool. If the dataset contains zero valid rows after validation, notify the user and halt further processing.

Also, in various embodiments the prompt template can include information—such as an example format structure—that instructs the agent as to a format to be used for the table that it generates. The curly-brace delimited placeholders included in the above prompt template example can, for instance, be dynamically populated through the action of code (e.g., Python code) associated with the entity agent 1103 in a manner analogous to that discussed above.

After using the entity agent 1103, the system can apply the target agent 1105 (also referred to as the core set agent). The target agent 1105 can employ prompt engineering-based functionality, tools, and/or conventional code-based functionality to perform multiple actions. These actions can include receiving the data structure (e.g., named sampled_entities) produced by the entity agent 1103 and generating a further data structure (e.g., a database table named core_set). In particular, for classification tasks the target agent 1105 can, for example, determine whether the target activity occurred for given entity-date pairs. Further in particular, for regression tasks the target agent 1105 can, for example, calculate the value of the the target for given entity-date pairs. This process can be referred to as labeling, where the agent assigns outcomes to training examples.

The resulting data structure (e.g., database table named core_set) can include, for example, columns for: a) the entity identifier; b) the sampling date; and/or c) the computed target label or value. This data structure can, for example, serve as a basis for subsequent feature engineering and/or model training steps. Once the data structure has been generated by the target agent 1105, The system can pass the data structure to subsequent agents in the chain.

In an aspect, the target agent 1105 can perform data discovery. This data discovery can include the target agent 1105 identifying one or more data sources that contain relevant information about the target (e.g., that contain relevant information about the target activity or value). These data sources can include, for example, one or more database tables that: a) record the occurrence of the target activity (e.g., purchases and/or churn events); and/or b) store the values to be predicted (e.g., total spend and/or transaction amounts).

For example, in performing the data discovery operations the target agent 1105 can leverage tools and/or employ schema exploration to: a) examine available data sources; b) determine which tables are relevant for the at-hand target (e.g., as specified by the data structure received from the goals agent 1101); and/or c) map the appropriate columns for use in subsequent target operations. This mapping process can include reviewing table names, column names, data types, and/or sample values to, for instance, ensure that the one or more selected data sources are suitable for extracting the target information that the agent can use for performing labeling with respect to the the data structure (e.g., named sampled_entities) generated by the entity agent 1103.

As just an example, the target agent 1105 can use a prompt template that includes the following:

### System Message

You are a target data discovery agent responsible for identifying the data source(s) containing the target activity and/or value information for a predictive modeling task. You have access to the following tools:
list_connections_tool: Lists available database connections.
list_tables_tool: Lists tables in a selected database connection.

### User Prompt

You have received and/or have access to the following model elements for a predictive modeling task:
(Known from received model_elements) Target definition: {target_definition} (e.g., purchase event, total spend)
(Known from received model_elements) Description of target activity or value: {target_description}

Your task is to:
1) Use list_connections_tool to identify available database connections.
2) For each connection, use list_tables_tool to list the tables.
3) Explore the available tables and columns to identify which data source(s) contain information about the target activity or value specified by {target_definition}.
4) Map the relevant table(s) and column(s) that will be used to extract the target information for downstream processing.

Also, in various embodiments the prompt template can include information—such as an example format structure—that instructs the agent as to a format to be used for the target data source mapping that it generates. The curly-brace delimited placeholders included in the above prompt template example can, for instance, be dynamically populated through the action of code (e.g., Python code) associated with the target agent 1105 in a manner analogous to that discussed above.

After performing data discovery, the target agent 1105 can proceed to target computation. This target computation can include the agent generating and/or executing a query (e.g., a SQL query) that joins the data structure (e.g., a database table named sampled_entities) that is output by the entity agent 1103 with the relevant target data table identified by the data discovery operations performed by the target agent 1105. This join can, for example, associate, for a given entity-date pair, the corresponding target information that can be used for labeling.

For a given row in the joined table, target agent 1105 can look forward in time over the prediction time horizon (e.g., the next 7 days) to determine the corresponding outcome. For classification tasks, the agent can, for example, assign a boolean label to a given entity-date pair. This label can indicate whether the target activity (e.g., making a purchase) occurred within the prediction time horizon. These labels (e.g., having values such as True/False or 1/0) can later be stored in a column (e.g., a column named did_purchase) in a data structure (e.g., a database table named core_set). For regression tasks, the agent can, for example, calculate a numerical value label for a given entity-date pair. This label can indicate a numerical value (e.g., a total spend value) for the prediction time horizon. These labels (e.g., having values such as 120.50, 0.00, or 87.99) can be stored in a column (e.g., a column named total_spend_next_7_days) in the noted data structure (e.g., table). In this way, the target agent 1105 can, for example, label the sampled entity-date pairs with corresponding outcomes.

As just an example, the target agent 1105 can use a prompt template that includes the following:

### System Message

You are a target computation agent responsible for generating and executing a query to join the sampled_entities table with the relevant target data table, and for labeling the entity-date pairs with appropriate outcomes for a predictive modeling task. You have access to the following tool:
run_query_and_save_result_tool: Executes SQL queries and returns the result.

### User Prompt

You have received and/or have access to the following model elements for a predictive modeling task:
(Known from received sampled_entities) Sampled entities: {sampled_entities}
(Known from received sampled_entities) Entity identifier column: {entity_id_column}
(Known from received sampled_entities) Sampling date column: {sampling_date_column}
(Known from your data discovery operations) Target data table: {target_data_table}
(Known from your data discovery operations) Target activity or value column: {target_column}
(Known from received model_elements) Prediction time horizon: {prediction_time_horizon}
(Known from received model_elements) Task type: {task_type} (e.g., classification, regression)

Your task is to:
1) Construct a SQL query that joins {sampled_entities} with {target_data_table} using {entity_id_column}.
2) For each row in the table that results from the join, look forward in time from {sampling_date_column} over the {prediction_time_horizon} to determine the outcome using {target_column}.
3) For classification tasks, create a boolean label indicating whether the target activity occurred within the prediction time horizon.
4) For regression tasks, calculate a numerical value (e.g., total spend) within the prediction time horizon.
5) Use run_query_and_save_result_tool to execute the query and retrieve the result.

Also, in various embodiments the prompt template can include information (e.g., an example format structure) that instructs the agent as to a format to be applied to the result that it receives from the run_query_and_save_result_tool. The curly-brace delimited placeholders included in the above prompt template example can, for instance, be dynamically populated through the action of code (e.g., Python code) associated with the target agent 1105 in a manner analogous to that discussed above.

After performing target computation, the target agent 1105 can perform dataset creation. Here, the agent can generate a data structure (e.g., a database table named core_set) that contains, for example, the entity identifier, the sampling date, and the determined target label or value for given instances. The agent can generate this data structure using the results of the discussed target determination, ensuring, for example, that for a given entity-date pair, the corresponding outcome (e.g., a boolean label for classification or a numerical value for regression) can be included in the output. This data structure can serve as a foundation for one or more model training sets generated by the attributes agent 1107.

As just an example, the target agent 1105 can use a prompt template that includes the following:

### System Message

You are a dataset creation agent responsible for generating a data structure (e.g., a database table named core_set) that contains entity identifiers, sampling dates, and determined target labels or values for a predictive modeling task. You have access to the following tool:
save_table_tool: Saves a dataset as a named table in the database.

### User Prompt

You have received and/or have access to the following data for a predictive modeling task:
(Known from target computation operations) Entity identifier column: {entity_id_column}
(Known from target computation operations) Sampling date column: {sampling_date_column}
(Known from target computation operations) Computed target label or value column: {target_column}

Your task is to:
1) Validate that the labeled dataset contains non-missing values in the entity identifier, sampling date, and target columns.
2) Save the validated dataset as a table named core_set using save_table_tool.

Also, in various embodiments the prompt template can include information (e.g., an example format structure) that instructs the agent as to a format to be used for the table that it generates. Further, the curly-brace delimited placeholders included in the above prompt template example can, for instance, be dynamically populated through the action of code (e.g., Python code) associated with the target agent 1105 in a manner analogous to that discussed above.

After employing the target agent 1105, the system can apply the attributes agent 1107. The attributes agent 1107 can use prompt engineering-based functionality, tools, and/or conventional code-based functionality to perform various actions. These actions can include receiving the data structure (e.g., named core_set) from the target agent 1105 and generating a further data structure (e.g., a database table named training_dataset) that can be passed by the system to further agents of the chain.

More specifically, the attributes agent 1107 can perform operations including enriching, based on historical behavior and/or static attributes of the entities, the received data structure with predictive features. The resultant generated data structure can, for example, contain not only entity identifiers, sampling dates, and target outcomes, but also engineered features resulting from the enrichment operations performed by the attributes agent 1107. In this way, the attributes agent 1107 can create a feature-rich dataset for model training.

After receiving the data structure generated by the target agent 1105 (e.g., a database table named core_set), the attributes agent 1107 can perform feature generation and query execution. In particular, the attributes agent 1107 can generate (e.g., systematically generate) predictive features by, for example, analyzing entity activity in the time period before given sampling dates. The attributes agent 1107 can use prompt engineering-based functionality, tools, and/or conventional code-based functionality to support this process.

The features generated by the attributes agent 1107 can include both features that are present as raw data in the underlying tables and features that are calculated or engineered by the agent based on such raw values. For example, the attributes agent 1107 can create features that capture recency (e.g., the time since the last activity prior to the sampling date), frequency (e.g., the number of actions and/or sessions in a specified window before the sampling date), and/or monetary value (e.g., the total amount spent in a given period). Said somewhat differently, the attributes agent 1107 can create features that capture “RFM,” where RFM stands for “Recency, Frequency, and Monetary Value.” Additional features created by the attributes agent 1107 can regard various behavioral patterns, such as the number of sessions, the time between events (e.g., the average time between events), and/or the product categories viewed by the entity (e.g., the number of distinct product categories viewed by the entity in the period leading up to the sampling date).

To compute these features for the relevant entity-date pairs in the data structure generated by the target agent 1105 (e.g., database table named core_set), the attributes agent 1107 can generate and execute one or more SQL queries. These SQL queries can, for example, aggregate and/or calculate the desired feature values using appropriate tables and/or columns. In this way, the attributes agent 1107 can produce one or more sets of engineered features that enrich the dataset with information that can be used by machine learning models to learn relevant patterns.

As just an example, the attributes agent 1107 can use a prompt template that includes the following:

### System Message

You are a feature generation and query execution agent responsible for systematically generating predictive features for a machine learning modeling task. You have access to the following tools:
list_connections_tool: Lists available database connections.
list_tables_tool: Lists tables in a selected database connection.
run_query_and_save_result_tool: Executes SQL queries and returns the result.

### User Prompt

You have received and/or have access to the following data for a predictive modeling task:
(Known from received core_set) Entity identifier column: {entity_id_column}
(Known from received core_set) Sampling date column: {sampling_date_column}
(Known from received core_set or accompanying metadata) Historical behavior tables and columns: {behavior_tables_and_columns}
(Known from received core_set or accompanying metadata) Static attribute tables and columns: {attribute_tables_and_columns}

Your task is to:
1. For given entity-date pairs, generate predictive features by analyzing activity in the period before the sampling date. Features can include recency (e.g., time since last activity), frequency (e.g., number of actions in a window), monetary value (e.g., total spend), number of sessions, average time between events, and number of product categories viewed.
2. Generate SQL queries to aggregate or compute these features using the relevant tables and columns.
3. Execute the SQL queries to compute the feature values for the relevant entity identifiers and sampling date pairs.

Also, in various embodiments the prompt template can include information—such as an example format structure—that instructs the agent as to a format to be used for the data that it generates. Further, the curly-brace delimited placeholders included in the above prompt template example can, for instance, be dynamically populated through the action of code (e.g., Python code) associated with the attributes agent 1107 in a manner analogous to that discussed above.

After carrying out the feature generation and query execution operations, the attributes agent 1107 can perform dataset augmentation. This dataset augmentation can include the agent joining the results of the feature generation queries with the data structure received from the target agent 1105 (e.g., the core_set table). Through this join operation, the agent can add columns corresponding to the engineered features to the dataset. As such, the resulting data structure (e.g., a database table named training_dataset) can include, for example, entity identifiers, sampling dates, target outcomes, and/or engineered features. This feature-rich dataset can then be used as input for model training in subsequent steps of the predictive modeling workflow.

As just an example, the attributes agent 1107 can use a prompt template that includes the following:

### System Message

You are a dataset creation agent responsible for joining computed feature results with the core_set data structure, thereby augmenting the dataset with engineered feature columns for a predictive modeling task. You have access to the following tool:
run_query_and_save_result_tool: Executes SQL queries and returns the result.

### User Prompt

You have received and/or have access to the following data for a predictive modeling task:
(Known from received core_set) Core set table: {core_set_table}
(Known from received core_set) Entity identifier column: {entity_id_column}
(Known from received core_set) Sampling date column: {sampling_date_column}
(Known from your feature generation and query execution operations) Feature columns and data: {feature_columns_and_data}

Your task is to:
1) Join the computed feature columns and data ({feature_columns_and_data}) with {core_set_table} using {entity_id_column} and {sampling_date_column}.
2) Output the database table that results from the join.

Also, in various embodiments the prompt template can include information (e.g., as an example format structure) that instructs the agent as to a format to be used for the database table that results from the join. Further, the curly-brace delimited placeholders included in the above prompt template example can, for instance, be dynamically populated through the action of code (e.g., Python code) associated with the attributes agent 1107 in a manner analogous to that discussed above.

After employing the attributes agent 1107, the system can apply the modeling agent 1109. The modeling agent 1109 can use prompt engineering-based functionality, tools, and/or conventional code-based functionality to perform various actions. These actions can include receiving the data structure (e.g., named training_dataset) generated by the attributes agent 1107 and outputting one or more trained predictive models and/or associated performance reports.

The modeling agent 1109 can, for example, use the data structure received from the attributes agent 1107 to train, evaluate, and/or select one or more predictive models. More specifically, the actions performed by the modeling agent 1109 can include applying one or more machine learning algorithms to the training dataset (e.g., named training_dataset), evaluating model performance using one or more system-selected metrics, and/or choosing one or more models (e.g., one or more validated predictive models) for deployment.

The modeling agent 1109 can use the data structure received from the attributes agent 1107 (e.g., a database table named training_dataset) in performing model training. Here, the modeling agent 1109 can apply one or more machine learning algorithms to the training dataset. The agent can choose one or more algorithms that are suitable for the prediction task at hand. As just some examples, the modeling agent 1109 can use gradient boosting tree models for classification tasks and/or linear regression models for value prediction tasks. The agent can, for example, leverage information specified earlier in the workflow (e.g., the task type) to guide the selection and/or application of appropriate algorithms.

As just an example, the modeling agent 1109 can use a prompt template that includes the following:

### System Message

You are a model training agent responsible for applying one or more machine learning algorithms to a training dataset for a predictive modeling task. You have access to the following tools:
list_algorithms_tool: Lists available machine learning algorithms.
train_model_tool: Trains a machine learning model using a specified algorithm and dataset.

### User Prompt

You have received and/or have access to the following data for a predictive modeling task:
(Known from received training_dataset) Training dataset: {training_dataset}
(Known from received model_elements) Task type: {task_type} (e.g., classification, regression)

Your task is to:
1. Use the list_algorithms_tool to identify available machine learning algorithms suitable for the prediction task specified by {task_type}.
2. Select one or more appropriate algorithms (e.g., gradient boosting trees for classification, linear regression for value prediction).
3. Use the train_model_tool to train a model (or models) using the selected algorithm(s) and the {training_dataset}.
4. Output the trained model(s) and corresponding training reports for further evaluation and selection.

Also, in various embodiments the prompt template can include information—such as an example format structure—that instructs the agent as to a format to be used for the outputted training reports. Further, the curly-brace delimited placeholders included in the above prompt template example can, for instance, be dynamically populated through the action of code (e.g., Python code) associated with the modeling agent 1109 in a manner analogous to that discussed above.

After training the one or more predictive models, the modeling agent 1109 can perform model evaluation. For example, the agent can evaluate (e.g., rigorously evaluate) the trained models by splitting the available data into training and/or validation sets. As another example, the agent can use cross-validation. In this way, the agent can achieve beneficial results including assessing model robustness and/or generalizability.

The modeling agent 1109 can, in various embodiments, compute relevant performance metrics for the trained models. For classification, the metrics can include Area Under the Curve (AUC). For regression, the metrics can include Root Mean Squared Error (RMSE). The computed metrics can be used, for example, to inform subsequent model selection by the modeling agent 1109.

As just an example, the modeling agent 1109 can use a prompt template that includes the following:

### System Message

You are a model evaluation agent responsible for evaluating trained machine learning models for a predictive modeling task. You have access to the following tools:
split_data_tool: Splits a dataset into training and validation sets.
cross_validation_tool: Performs cross-validation on a model and dataset.
compute_metrics_tool: Computes performance metrics for a model.

### User Prompt

You have received and/or have access to the following data for a predictive modeling task:
(Known from your model training operations) Trained model(s): {trained models}
(Known from received training_dataset) Training dataset: {training_dataset}
(Known from received model_elements) Task type: {task_type} (e.g., classification, regression)

Performance metrics: {performance_metrics} (e.g., AUC, RMSE)

Your task is to:
1. Use split_data_tool to split {training_dataset} into training and validation sets.
2. Use cross_validation_tool to perform cross-validation on {trained_models} using the training and validation sets.
3. Use compute_metrics_tool to compute {performance_metrics} for the trained models.
4. Output the evaluation results and the performance metrics.

Also, in various embodiments the prompt template can include information—such as example format structures—that instruct the agent as to formats to be used for the evaluation results and the performance metrics. Further, the curly-brace delimited placeholders included in the above prompt template example can, for instance, be dynamically populated through the action of code (e.g., Python code) associated with the modeling agent 1109 in a manner analogous to that discussed above.

After performing model evaluation, the modeling agent 1109 can perform model selection. Here, the modeling agent 1109 can, based on the metrics computed during model evaluation, select one or more of the trained models (e.g., the best-performing model) for further use.

As just an example, the modeling agent 1109 can use a prompt template that includes the following:

### System Message

You are a model selection agent responsible for selecting one or more models from a set of trained models for a predictive modeling task. You have access to the following tool:
select_model_tool: Uses one or more evaluation metrics as a basis for selecting one or more models.

### User Prompt

You have received and/or have access to the following data for a predictive modeling task:
(Known from your model training operations) Trained model(s): {trained models}
(Known from your model evaluation operations) Evaluation results and performance metrics: {evaluation_results}

Your task is to:
1) Use select_model_tool to select one or more models from {trained_models} based on {evaluation_results}.
2) Output the selected one or more models for further deployment or analysis.

Also, in various embodiments the prompt template can include information—such as an example format structure—that instructs the agent as to a format to be used for the outputted model selection results. Further, the curly-brace delimited placeholders included in the above prompt template example can, for instance, be dynamically populated through the action of code (e.g., Python code) associated with the modeling agent 1109 in a manner analogous to that discussed above.

After performing model selection, the modeling agent 1109 can perform output generation. This output generation can include the modeling agent 1109 generating outputs (e.g., final outputs) for the predictive modeling workflow.

These outputs can include, for example: a) one or more serialized, trained models that are ready for deployment; and/or b) one or more performance reports (e.g., comprehensive performance reports) that detail, for instance, accuracy and/or other metrics (e.g., key metrics). The outputs generated by the modeling agent 1109 can, for example, be used for deployment, integration with other systems, review, and/or analysis.

As just an example, the modeling agent 1109 can use a prompt template that includes the following:

### System Message

You are an output generation agent responsible for outputting serialized models and performance reports for a predictive modeling task. You have access to the following tools:
serialize_model_tool: Serializes one or more trained models for deployment.
generate_report_tool: Generates one or more performance reports for one or more trained models.

### User Prompt

You have received and/or have access to the following data for a predictive modeling task:
(Known from your model selection operations) Selected model(s): {selected_models}
(Known from your model evaluation operations) Performance metrics: {performance_metrics}

Your task is to:
1. Use serialize_model_tool to serialize {selected_models} for deployment.
2. Use generate_report_tool to generate one or more performance reports for {selected_models}, including {performance_metrics}.
3. Output the one or more serialized models and the one or more performance reports.

Also, in various embodiments the prompt template can include information that instructs the agent as to one or more file types (e.g., .pkl and/or .joblib) to be used for the one or more serialized models, and/or one or more formats to be used for the one or more performance reports. Further, the curly-brace delimited placeholders included in the above prompt template example can, for instance, be dynamically populated through the action of code (e.g., Python code) associated with the modeling agent 1109 in a manner analogous to that discussed above.

As such, in various embodiments, the goals agent conducts an interactive natural language dialogue with a user to elicit business objectives without requiring that the user possess machine learning and/or technical expertise. Further, in some embodiments, the goals agent automatically samples user data sources (e.g., during a dialogue) to identify available tables and/or columns, and to recommend predictive questions based on detected data patterns. Also, the goals agent can translate unstructured business use case descriptions into structured model elements, engage the user in a structured dialogue to elicit components of a predictive question, identify an entity subject for prediction, and/or determine a target activity for classification models and/or a target value for regression models.

In some embodiments, the goals agent can clarify temporal characteristics of the prediction, such as distinguishing between recurring predictions made at regular intervals and event-based predictions triggered by specific actions. The goals agent defines entity filters to refine a population for which predictions are made and/or adaptively guide the dialogue flow by, for instance, recognizing complete versus incomplete descriptions and asking clarifying questions. The goals agent can synthesize obtained information into a formal predictive question (e.g., represented as a structured dictionary of model elements). Further still, in various embodiments, the goals agent can obtain explicit user confirmation before proceeding.

Additionally as such, in various embodiments, the entity agent receives the structured dictionary of model elements from the goals agent and connect to one or more user data sources. The entity agent differentiates between recurring predictions made at regular intervals and event-based predictions triggered by specific actions. Further, the entity agent validates that sufficient temporal data exists to support the specified prediction type. Also, the agent can map behavioral and/or attribute filters to specific tables and columns in the data sources.

For recurring prediction models, the entity agent can generate multiple prediction snapshots across a historical timeline at specified frequencies by querying behavioral activity tables. For event-based models, the agent can identify occurrences of triggering events and calculate prediction timing by applying specified time offsets to triggering event dates. The entity agent can also construct and/or execute SQL queries to identify entities satisfying defined filters as of given sampling dates. Additionally, the agent can enforce temporal safety, ensuring that the sampling logic does not reference future information. The entity agent can further generate a sampled entities dataset containing entity identifiers and corresponding sampling dates.

Also as such, in various embodiments, the target agent can receive the sampled entities dataset and identify one or more data sources containing target activity and/or target value information. The target agent can also generate and/or execute SQL queries that join the sampled entities dataset with target data tables, such as by using query logic that preserves entity-date pairs (e.g., all entity-date pairs), including those representing negative examples. Further, for given entity-date pairs, the target agent can determine outcomes by analyzing data within a prediction time horizon.

The target agent can, in various embodiments, enforce temporal safety by ensuring that target computations use only data occurring after the sampling dates, thereby helping to prevent data leakage. Additionally, the agent can validate data completeness by filtering out entity-date pairs where the prediction time horizon extends beyond the available data. For LTV prediction cases, the target agent can, for example, aggregate data from triggering event dates forward and compute values representing accumulated lifetime value, such as min_calibration values. Further, the target agent can create a core set dataset containing entity identifiers, sampling dates, and/or computed target labels (for classification tasks) and/or target values (for regression tasks).

Further as such, in various embodiments, the attributes agent can receive the core set dataset and identify available attribute tables, analyzing columns to determine column types. The attributes agent can compute cardinality metrics, including distinct value counts and/or the percentage of rows with unique values. Additionally, the agent can exclude high-cardinality identifier columns and/or low-quality features based on null rates and data quality thresholds.

The attributes agent can systematically generate predictive features by analyzing entity activity in time periods before given sampling dates. Also, the agent can recommend advanced feature combinations, including both entity-centric and/or group-centric calculations. In various embodiments, the attributes agent can apply domain-specific feature engineering patterns tailored to prediction types, such as LTV, churn, demand forecasting, and/or conversion models.

Further, the agent can generate derived features, including ratios between related metrics, trend calculations over time windows, time-spent features, and/or interaction features across multiple columns. The attributes agent can also filter redundant features that are equivalent to basic single-column aggregations automatically computed during model training. Additionally, the agent can execute SQL queries to calculate feature values for given entity-date pairs and/or progressively join computed features to the core set dataset. In this way, the attributes agent can, for instance, produce a feature-rich training dataset.

Additionally as such, in various embodiments, the modeling agent can receive the feature-rich training dataset and validate that the core set dataset contains unique entity-date pairs, proper date types, and/or an appropriate target distribution. The modeling agent can also validate that attribute tables contain additional predictive features and/or appropriate columns for joining, while excluding target columns to help prevent data leakage.

The modeling agent can partition the training dataset into a training subset and/or a test subset using multiple split methodologies, including chronological percentage splits, chronological date-based splits, and/or custom column splits. Further, the agent can, in various embodiments, enforce split constraints to help ensure that both subsets contain at least two distinct outcome values and/or meet minimum size requirements. The modeling agent can flatten the core set and attribute tables into a unified training dataset.

Additionally, the modeling agent can apply one or more machine learning algorithms suitable for the prediction task, perform hyperparameter selection and/or model optimization, and/or automatically detect and handle outliers using statistical methods during model training. The agent can evaluate trained models using cross-validation on the training subset and/or performance metrics on the test subset. Further, the modeling agent can automatically detect and/or remediate data leakage through systematic health checks. The modeling agent can also generate one or more serialized trained models and/or performance reports.

It is noted that the discussed agents can, in various embodiments, operate sequentially, such as by passing structured datasets and/or model elements to one another in order to ensure a coherent workflow from business objective definition to deployed predictive model. Also, in various embodiments the system can include a conversational interface module. The conversational interface module can perform actions including facilitating interactive dialogue between a user and the noted software agents. As just an example, the conversational interface module can be incorporated within the LLM module 115.

Also as such, in various embodiments, the goals agent can conduct an interactive natural language dialogue with a user to elicit business objectives and/or use case requirements, without requiring that the user possess machine learning and/or technical expertise. The goals agent can translate unstructured business use case descriptions into a structured dictionary of model elements, which can include: a) entity definitions identifying subjects of prediction within the business context; b) target activity definitions for classification models and/or target value definitions for regression models, expressed in business terminology but mapped to data source columns; c) temporal characteristics such as prediction time horizons, prediction frequencies, and/or triggering events; and/or e) entity filters and/or target filters constraining the prediction scope.

Additionally, the goals agent can automatically sample user data sources during the dialogue to: a) identify available tables and/or columns relevant to the business use case; b) recommend predictive questions based on detected data patterns and business context; c) validate that suggested target activities and/or values can be derived from available data; and/or d) present two or more questions (or another quantity of questions) in natural language for user selection. The questions can be contextually relevant predictive questions.

Further, the goals agent can adaptively guide the dialogue flow by: a) recognizing when a user has provided a complete predictive question versus an incomplete description; b) asking clarifying questions one at a time to avoid overwhelming non-technical users; c) providing contextual examples based on the user's industry and/or available data; d) distinguishing between time-based and/or non-time-based predictions (e.g., based on data availability); and/or e) restricting behavioral filters and/or time-based target filters when no temporal data exists.

The goals agent can also formalize the conversational exchange into a machine-actionable structured representation, wherein: a) natural language business concepts can be mapped to specific data tables and/or columns; b) temporal business requirements can be converted to precise time horizon parameters; and/or c) entity and/or target constraints can be expressed as filter predicates applicable to downstream SQL query generation. The structured dictionary can be consumable by subsequent specialized agents without further human interpretation.

Additionally, the goals agent can present the formalized model elements to the user for confirmation before proceeding, enabling, for instance, non-technical business users to verify that the system correctly understood their business objectives. In this way, the goals agent can bridge the gap between business use case articulation and technical machine learning model specification through conversational artificial intelligence, thereby, for example, eliminating the need for users to understand model architecture, feature engineering, and/or statistical concepts.

Additionally as such, in various embodiments, the entity agent can include a prediction type classification module. The prediction type classification module can perform operations including differentiating between recurring predictions made at regular intervals (e.g., daily, weekly, monthly) regardless of specific user actions, and event-based predictions triggered by specific user actions. For recurring predictions, entity sampling can occur across multiple time periods to support training models on behavioral patterns that repeat over time. For event-based predictions, entity sampling can be anchored to the occurrence of a triggering event, with predictions generated at a specified time relative to when that event occurred.

The entity agent can, in various embodiments, include a data discovery and validation module. The data discovery and validation module can perform operations including: a) analyzing available data sources to identify temporal columns essential for temporal modeling; b) validating that sufficient temporal data exists to support the specified prediction type; c) when temporal data is unavailable, halting the sampling process and/or providing options to add temporal data and/or convert to a non-time-based prediction model; and/or automatically modifying model elements when users elect to proceed without temporal constraints.

In various embodiments, the entity agent can include a recurring prediction entity sampling module. The recurring prediction entity sampling module can perform operations including: a) generating multiple prediction snapshots across a historical timeline at specified frequencies (e.g., daily, weekly, and/or monthly intervals); b) identifying behavioral activity tables and extracting date ranges representing when entities performed relevant behaviors; and/or c) sampling entities that satisfy behavioral filter criteria (e.g., as of given prediction snapshot dates). Alternately or additionally, the recurring prediction entity sampling module can perform operations including: a) applying attribute-based filters in combination with behavioral filters; b) generating a sampled entities dataset containing entity identifiers paired with multiple sampling dates (e.g., to enable learning from recurring behavioral patterns); and/or c) in various embodiments requiring behavioral filters as mandatory components given that recurring prediction models can fundamentally predict future behavior based on past activity patterns.

Further, the entity agent can include an event-based prediction entity sampling module. The event-based prediction entity sampling module can perform operations including: a) identifying triggering event occurrences that initiate the prediction timeline (e.g., signup events, first purchases, app installations); b) calculating prediction timing, such as by applying specified time offsets to triggering event dates (e.g., “7 days after signup”); and/or c) when no time offset is specified, generating predictions at the triggering event (e.g., immediately at the triggering event).

Alternately or additionally, the event-based prediction entity sampling module can perform operations including: a) applying entity filters based on attribute criteria and/or behavioral patterns relative to the triggering event; b) generating a sampled entities dataset, such as one containing entity identifiers paired with prediction dates derived from triggering event timestamps; and/or c) ensuring that a given entity appears once corresponding to when their triggering event occurred.

Additionally, the entity agent can, in various embodiments, include a query generation module. The query generation module can perform operations including translating entity definitions, filters, and/or temporal constraints into data extraction queries and/or enforcing temporal safety (e.g., by ensuring sampling logic does not reference future information). Also, in various embodiments the query generation module can execute queries and/or save results (e.g., to named datasets consumable by downstream agents).

Further still, in various embodiments, the entity agent can include a validation module. The validation module can perform operations including validating that sampled entities datasets contain sufficient entity-date pairs, invoking diagnostic tools when zero results are returned to identify root causes, presenting sampling results with summary statistics, and/or signaling completion to initiate handoff (e.g., to the target agent).

In this way, the entity agent can, for example, autonomously determine the appropriate entity sampling strategy based on prediction type classification, correctly identify entities relevant to recurring behavioral pattern predictions and/or event-triggered predictions, validate temporal data availability, and/or generate temporally sound entity datasets, thereby enabling non-technical users to build predictive models without requiring an understanding of sampling methodologies or temporal data modeling.

Also as such, in various embodiments, the target agent can include a prediction task classifier. The prediction task classifier can determine whether to compute classification labels, regression target values, and/or LTV metrics. The target agent can, in various embodiments, include a target computation module. The target computation module can perform operations including: a) joining the sampled entities dataset with target data tables using query logic that preserves entity-date pairs (including negative examples); b) establishing future time horizon windows for given entity-date pairs; c) computing binary labels for classification and/or aggregate numerical values for regression within the future time horizon; and/or d) for LTV cases, aggregating data from triggering event dates forward and/or computing min_calibration values representing accumulated lifetime value up to the sampling date.

Additionally, the target agent can include a data completeness validation module. The data completeness validation module can perform operations including determining the maximum date for which complete data exists, filtering out entity-date pairs where the sampling date plus the future time horizon extends beyond available data, and/or preventing false negatives and/or incorrect target values due to incomplete data coverage. Further, the target agent can include a temporal safety enforcement module. The temporal safety enforcement module can, in various embodiments, help ensure that target computations use data occurring after sampling dates and/or apply temporal filters to help prevent data leakage. Further, the target agent can include a core set dataset generation module. The core set dataset generation module can produce a core set dataset containing entity identifiers, sampling dates, computed targets, and/or min_calibration values for LTV cases.

In this way, the target agent can, for example, use SQL logic to preserve negative examples essential for unbiased model training, enforce temporal safety to help prevent data leakage, validate data completeness, and/or handle LTV cases with cumulative aggregation logic.

Further as such, in various embodiments, the attributes agent can include a feature discovery module. The feature discovery module can perform operations including identifying available attribute tables containing entity characteristics and/or behavioral data, analyzing columns to determine column types (e.g., categorical, numeric, binary, and/or date features), computing cardinality metrics such as distinct value counts and/or the percentage of rows with unique values, and/or classifying columns as identifiers, business entities, and/or predictive features.

Additionally, the attributes agent can include a feature recommendation engine. The feature recommendation engine can perform operations including excluding high-cardinality identifier columns exceeding a uniqueness threshold to help prevent overfitting, excluding categorical columns with excessive distinct values (e.g., indicating free-text content), excluding features with null rates exceeding a data quality threshold, distinguishing between business entity identifiers suitable as features and/or transaction identifiers requiring exclusion, and/or automatically including low-cardinality features such as binary and/or categorical columns with manageable distinct values.

Also as such, in various embodiments, the attributes agent can include a temporal feature computation module. The temporal feature computation module can perform operations including generating time-windowed aggregations of behavioral data before given sampling dates, calculating features such as counts, sums, averages, and/or recency metrics within specified lookback periods, enforcing temporal safety (e.g., ensuring feature computations use only historical data available at prediction time), and/or joining computed features to the core set dataset while preserving entity-date pairs.

Additionally, the attributes agent can include a feature validation module. The feature validation module can validate that the feature-rich training dataset contains sufficient features and/or entity-date pairs before passing the dataset to the modeling agent.

In this way, the attributes agent can, for example, automatically perform feature engineering, cardinality analysis, and/or temporal safety enforcement without requiring user expertise in statistical analysis or feature selection.

Additionally as such, in various embodiments, the attributes agent can include a feature combination recommendation module. The operations performed by the feature combination recommendation module can include analyzing existing attribute queries and/or model elements to identify opportunities for advanced feature combinations. The operations performed by the feature combination recommendation module can also include distinguishing between entity-centric calculations (computed directly on predicted entities) and/or group-centric calculations (computed at group levels and joined back to entities). The operations performed by the feature combination recommendation module can further include recommending derived features such as ratios between related metrics, trend calculations over time windows, time-spent and/or duration features, and/or interaction features across multiple columns. Further still, the operations performed by the can include helping to ensure that recommended features use historical data available before given entity sampling dates to help prevent data leakage.

Additionally, the attributes agent can, in various embodiments, include a pattern-based feature generator. The pattern-based feature generator can apply domain-specific feature engineering patterns, which can include, for example: a) for LTV prediction models, revenue-until-prediction indicators, early-period revenue velocity metrics, and/or time-to-first-revenue features; b) for churn prediction models, engagement decay patterns, activity recency trends, and/or behavioral change indicators; c) for demand forecasting models, lagged demand features, price and/or promotion sensitivity calculations, product lifecycle stage indicators, and/or stockout flags; and/or d) for conversion prediction models, funnel progression metrics, session-based engagement features, and/or touchpoint sequence patterns.

In various embodiments, the attributes agent can include a temporal feature engineering module. The temporal feature engineering module can perform operations including generating first-event and/or last-event attribute extraction from transactional tables, calculating trend slopes of numeric attributes over defined time windows (e.g., using linear regression and/or difference methods), computing time-spent features by aggregating durations between timestamped events, and/or extracting time-since-last-event metrics for promotional activities and/or significant occurrences.

Further, the attributes agent can include an automated redundancy filter. The operations performed by the automated redundancy filter can include identifying and/or excluding feature recommendations equivalent to basic single-column aggregations automatically computed during model training. The operations performed by the automated redundancy filter can also include preventing suggestion of features redundant with automatic extractions (e.g., min, max, avg, median, stddev, sum for numeric columns, mode and/or count distinct for categorical columns, and/or date differences for temporal columns). The operations performed by the automated redundancy filter can additionally include allowing single-column aggregations when they carry unique business meaning beyond automatic computations.

In this way, the feature combination recommendation module can, for example, generate business-meaningful derived calculations that capture behavior patterns, velocity, intensity, and/or progression across events and columns, thereby providing advanced predictive signals beyond basic feature aggregations.

Additionally as such, in various embodiments, the modeling agent can include a dataset validation module. The dataset validation module can perform operations including validating that the core set dataset contains unique entity-date pairs, proper date types, and/or an appropriate target distribution. The dataset validation module can also validate that attribute tables contain additional predictive features and/or appropriate ID and/or date columns for joining, and/or can exclude target columns to help prevent data leakage. Further, the dataset validation module can verify successful joins between the core set and attribute tables, and/or ensure minimum row requirements for effective training.

The modeling agent can, in various embodiments, include a data split module. The data split module can perform operations including: a) partitioning the training dataset into a training subset and/or a test subset; b) supporting multiple split methodologies (e.g., chronological percentage splits, chronological date-based splits, and/or custom column splits); c) enforcing split constraints to help ensure that both subsets contain at least two distinct outcome values and/or meet minimum size requirements; and/or d) validating that user-specified split dates fall within the range of sampling dates.

Also, the modeling agent can include a model training module. The model training module can perform operations including: a) flattening the core set and attribute tables into a unified training dataset; b) automatically applying one or more machine learning algorithms suitable for the prediction task; c) performing hyperparameter selection and/or model optimization; d) evaluating trained models using cross-validation on the training subset and/or final evaluation on the test subset; and/or e) generating one or more serialized models and/or performance reports.

Further, the modeling agent can include a data leakage detection module. The data leakage detection module can perform operations including detecting and/or remediating data leakage through systematic health checks. The modeling agent can additionally include an outlier handling module, which can automatically detect and/or handle outliers using statistical methods during model training.

In this way, the modeling agent can, for example, validate dataset quality, manage data splitting with multiple methodologies, train and/or evaluate models automatically without user intervention in algorithm selection, and/or help ensure model integrity through leakage detection and/or outlier handling.

Also as such, in various embodiments, the modeling agent can include a dominant feature detector for data leakage detection. The dominant feature detector can perform operations including identifying features with importance scores exceeding a threshold percentage, determining if model performance metrics exceed expected ranges, and/or flagging features as potentially leaking target information.

Additionally, the modeling agent can include a null rate discrepancy detector for data leakage detection. The null rate discrepancy detector can perform operations including: a) calculating null rates for features separately for positive and/or negative outcome classes; b) determining if a difference in null rates exceeds a threshold and/or is statistically significant; and/or c) flagging features that are populated only after outcomes occur.

Also, in various embodiments, the modeling agent can include a future activity detector for data leakage detection. The future activity detector can perform operations including identifying features containing date values occurring after entity sampling dates, calculating differences in predicted scores between entities with and/or without future dates, and/or flagging features that reveal future information unavailable at prediction time.

Further, the modeling agent can include an investigation module for data leakage detection. The investigation module can perform operations including: a) tracing flagged features to corresponding columns in attribute tables; b) analyzing SQL queries generating the flagged features; c) determining whether flagged patterns represent confirmed leakage and/or false positives; and/or d) recommending remediation actions comprising column removal and/or query modification. Additionally, the modeling agent can include a remediation execution module for data leakage detection. The remediation execution module can execute approved remediation actions and/or regenerate the training dataset.

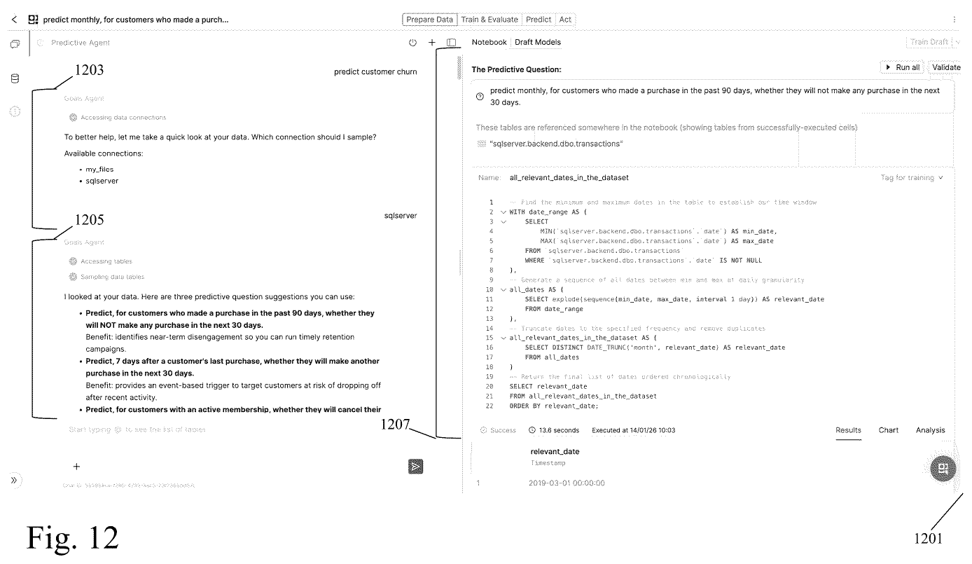

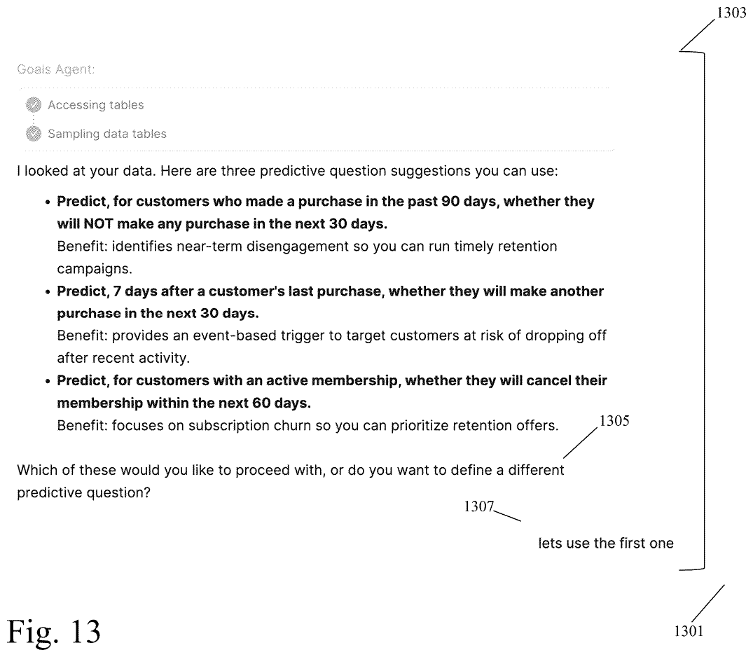

Turning to FIG. 12, shown is an example UI screen 1201 that allows a user to interact with one or more of the goals agent 1101, the entity agent 1103, the target agent (core set agent) 1105, the attributes agent 1107, and/or the modeling agent 1109. Included in FIG. 12 are UI areas 1203 and 1205 where the user interacts with the goals agent 1101. Also included in FIG. 12 is UI area 1207 displaying predictive question information to the user. Then, turning to FIG. 13, shown is sample UI screen 1301 that allows the user to interact with goals agent 1101. UI area 1303 of FIG. 13 provides additional detail on the user interaction depicted in UI area 1205 of FIG. 12. In particular, UI area 1303 shows the goals agent asking the user a question 1305 regarding selection from among offered predictive questions, and the user providing an answer 1307.

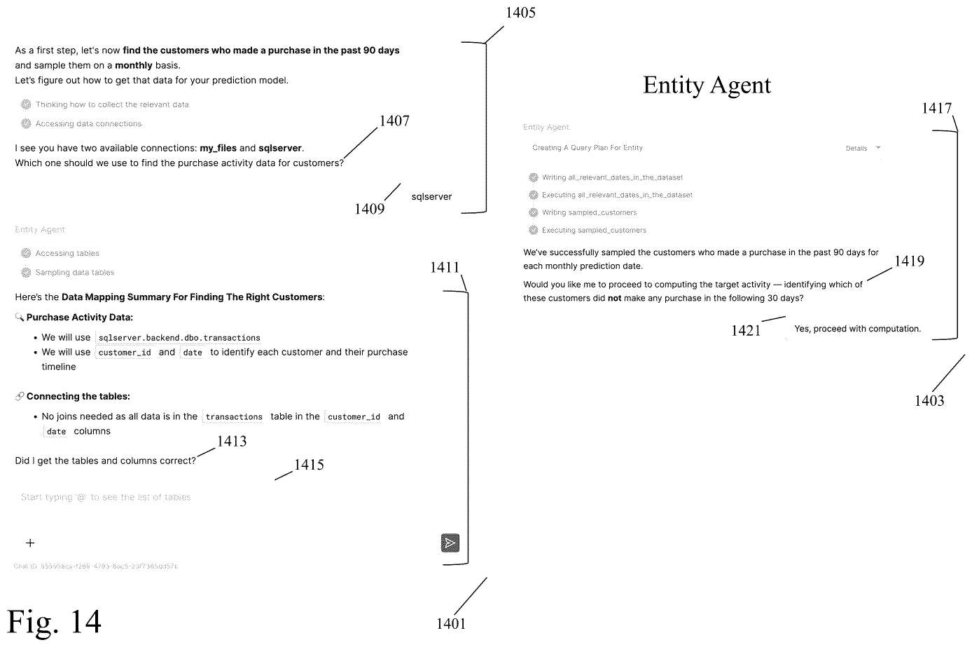

Turning to FIG. 14, shown are sample UI screens 1401 and 1403 that allow the user to interact with entity agent 1103. UI area 1405 shows the entity agent asking the user a question 1407 regarding which of two available connections to use, and shows the user providing answer 1409. Further, UI area 1411 depicts the entity agent asking the user a question 1413 as to whether it has correctly identified tables and columns. UI area 1411 provides UI element 1415 that allows the user to answer the question. Also shown in FIG. 14 is UI area 1417. Here, the entity agent asks (1419) the user to confirm whether target activity computation should proceed, and the user provides answer 1421.

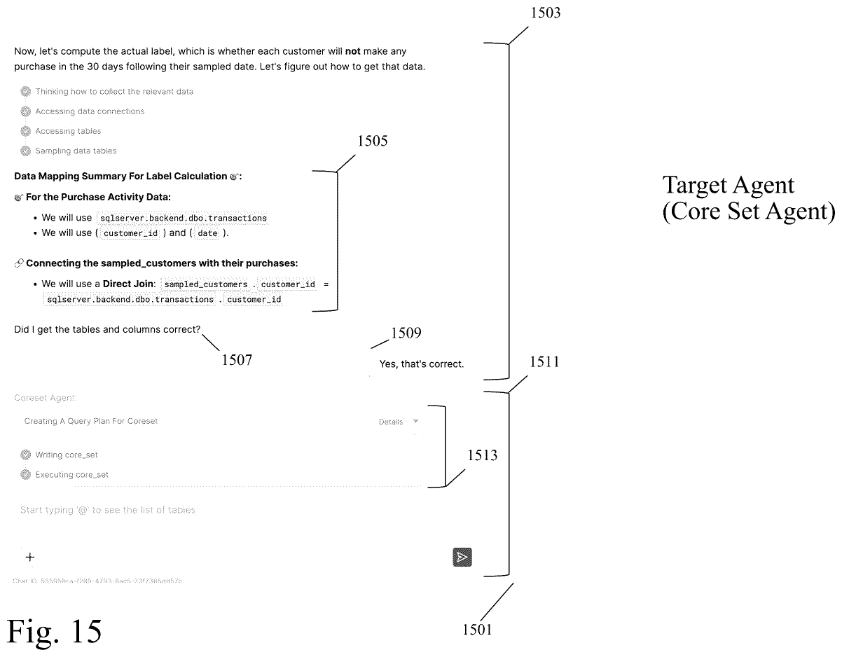

Turning to FIG. 15, shown is sample UI screen 1501 that allows the user to interact with target agent (core set agent) 1105. UI area 1503 shows the target agent displaying a data mapping summary 1505 to the user, and asking (1507) the user whether the tables and columns are correct. In reply, the user provides answer 1509. Then, UI area 1511 shows the target agent displaying its progress 1513 regarding creation of a query plan.

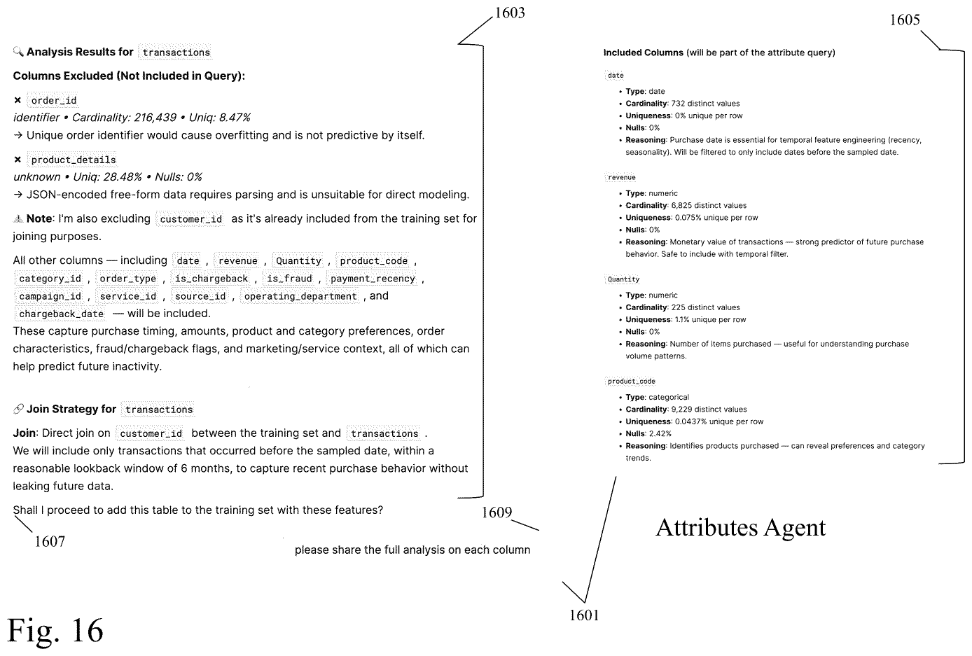

FIG. 16 shows sample UI screen 1601 that allows the user to interact with attributes agent 1107. UI area 1603 shows the attributes agent displaying analysis results. As depicted by the figure, these analysis results include an explanation of columns that are proposed to be excluded and an explanation of a proposed join strategy. Further, UI area 1605 provides an explanation of columns that are proposed to be included. UI screen 1601 also shows the attributes agent asking (1607) the user to confirm whether addition to the training set should proceed, and the user providing answer 1609.

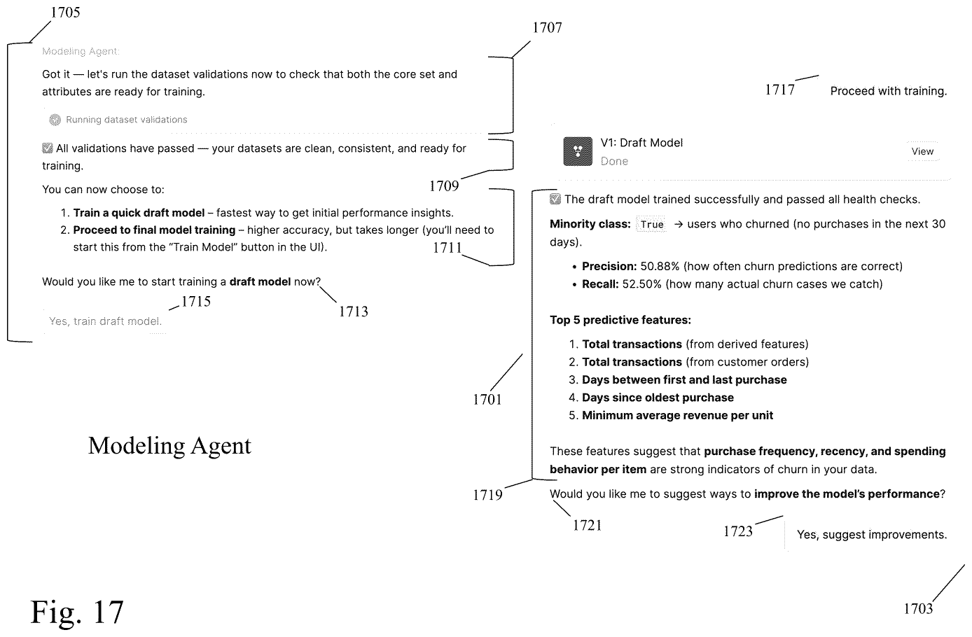

FIG. 17 shows sample UI screens 1701 and 1703 that allow the user to interact with modeling agent 1109. UI area 1705 includes indication 1707 regarding running of dataset validations. UI area 1705 further includes the agent explaining (1709) that validations have passed, and offering (1711) choices for training of a draft model and for training of a final model. UI area 1705 also shows the modeling agent asking (1713) whether the user desires to train a draft model, and the user providing answer 1715.

UI screen 1703 includes UI element 1717 providing access to model “V1: Draft model.” Also included in UI screen 1703 is display 1719 indicating that model training has been successful and providing various explanatory information. The figure depicts this explanatory information as including discussion of minority class, precision, recall, and top predictive features. The figure further depicts this explanatory information as including insight regarding feature significance. UI screen 1703 also shows the modeling agent asking (1721) the user whether suggestions for improving model performance are desired, and the user providing answer 1723.

### Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

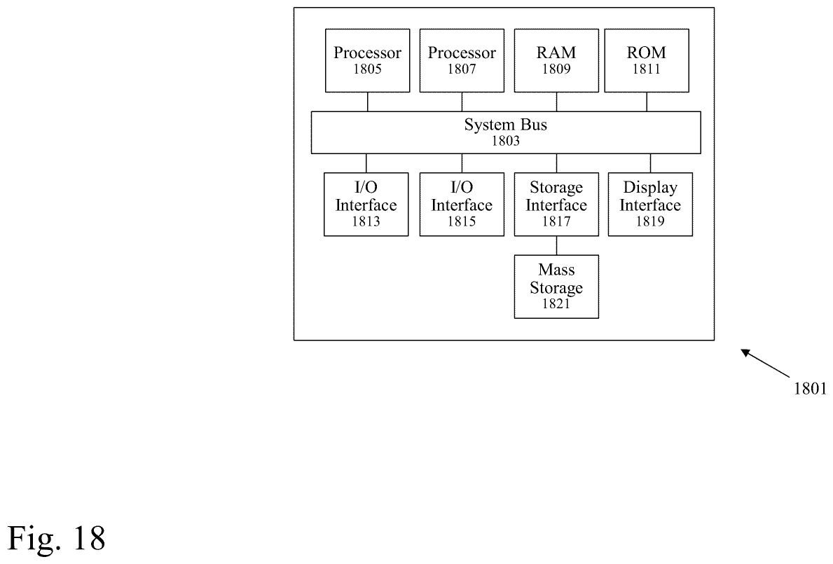

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 18 is an example computer employable in various embodiments of the present invention. Exemplary computer 1801 includes system bus 1803 which operatively connects two processors 1805 and 1807, random access memory (RAM) 1809, read-only memory (ROM) 1811, input output (I/O) interfaces 1813 and 1815, storage interface 1817, and display interface 1819. Storage interface 1817 in turn connects to mass storage 1821. Each of I/O interfaces 1813 and 1815 can, as just some examples, be a Universal Serial Bus (USB), a Thunderbolt, an Ethernet, a Bluetooth, a Long-Term Evolution (LTE), an IEEE 488 and/or other interface. Mass storage 1821 can be a flash drive, a hard drive, an optical drive, or a memory chip, as just some possibilities. Processors 1805 and 1807 can each be, as just some examples, a commonly known processor such as an ARM-based or x86-based processor. Computer 1801 can, in various embodiments, include or be connected to a touch screen, a mouse, and/or a keyboard. Computer 1801 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using Python, Java, Swift, C, C++, C#, and/or another language. Corresponding program code might be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module might instead be performed by a plurality of software modules. Similarly, any operations indicated as being performed by a plurality of modules might instead be performed by a single module. It is noted that operations indicated as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High-Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

### RAMIFICATIONS AND SCOPE

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

1. A system for generating one or more predictive machine learning models through a multi-agent framework, comprising:
a processor; and
a memory in operable communication with the processor, storing a set of instructions thereon, wherein said set of instructions causes the processor to execute an instance of one or more specialized software agents, wherein each specialized software agent is uniquely responsible for a distinct phase of a predictive model creation pipeline,
wherein said one or more specialized software agents includes a goals agent, an entity agent, a target agent, an attributes agent, and a modeling agent, and wherein the specialized software agents operate sequentially for generating the predictive machine learning models.

2. The system of claim 1, wherein said goals agent generates, using a large language model of a computing system, an interactive natural language dialogue interface with a user, and a structured dictionary of model elements based on input received from the user through the interactive natural language dialogue interface.

3. The system of claim 2, wherein said entity agent defines, using the large language model, a sampled entities data structure from the generated structured dictionary of model elements, wherein said sampled entities data structure includes entity identifiers and sampling dates.

4. The system of claim 3, wherein said entity agent executes one or more database queries from a data source to identify entities matching one or more filters based on the sampling dates.

5. The system of claim 3, wherein said target agent populates, using the large language model, a core set data structure from the defined sampled entities data structure, wherein the core set data structure includes one or more of:
one or more target activity occurrence determinations, or
one or more target value calculations.

6. The system of claim 5, wherein said attributes agent generates, using the large language model of the computing system, one or more training datasets.

7. The system of claim 5, wherein said attributes agent generates, using the large language model of the computing system, predictive features based on activity occurring prior to the sampling dates.

8. The system of claim 5, wherein said modeling agent generates, using the large language model of the computing system, a serialized trained model artifact and performance reports from the core set data structure.

9. The system of claim 1, wherein the generating the predictive machine learning models comprises generating a recurring prediction model, and said entity agent generates, using a large language model, one or more prediction snapshots across a historical timeline at a predefined frequency.

10. A computer-implemented method for generating one or more predictive machine learning models through a multi-agent framework, comprising:
presenting, using a goals agent executed by a processor, an interactive language dialogue to a user;
receiving input from the user through the interactive language dialogue;
generating a structured dictionary of model elements based on the received input;
defining, using an entity agent executed by the processor, a sampled entities data structure from the generated structured dictionary of model elements, wherein said sampled entities data structure includes entity identifiers and sampling dates;
populating, using a target agent executed by the processor, a core set data structure from the defined sampled entities data structure, wherein the core set data structure includes one or more of one or more target activity occurrence determinations, or one or more target value calculations; and
generating, using a modeling agent executed by the processor, a serialized trained model artifact and performance reports from the core set data structure.

11. The computer-implemented method of claim 10, wherein said populating the core set data structure from the defined sampled entities data structure comprises joining the sampled entities data structure with one or more target data tables for preserving all entity-date pairs.

12. The computer-implemented method of claim 10, further comprising generating, using an attributes agent executed by the processor, one or more training datasets.

13. The computer-implemented method of claim 10, further comprising generating, using an attributes agent executed by the processor, predictive features based on activity occurring prior to the sampling dates.

14. The computer-implemented method of claim 10, wherein said generating the predictive machine learning models comprises generating a recurring prediction model, the method further comprising generating, using an entity agent executed by the processor, one or more prediction snapshots across a historical timeline at a predefined frequency.

15. The computer-implemented method of claim 10, further comprising preparing a guide data structure, using the goals agent, wherein the guide data structure defines at least one of one or more entities for which predictions are to be made, one or more targets that are to be predicted, one or more prediction timings, or one or more prediction entity filters.

16. The computer-implemented method of claim 10, further comprising executing one or more relational database queries, using the entity agent executed by the processor, against a data source to identify entities matching one or more filters based on the sampling dates.

17. The computer-implemented method of claim 10, further comprising training, using the modeling agent, the one or more predictive machine learning models.

18. A non-transitory computer-readable storage medium including instructions that, when executed by at least one processor of a computing system, cause the computing system to perform a method for generating one or more predictive machine learning models through a multi-agent framework, the method comprising:
presenting, using a goals agent executed by a processor, an interactive language dialogue to a user;
receiving input from the user through the interactive language dialogue;
generating a structured dictionary of model elements based on the received input;
defining, using an entity agent executed by the processor, a sampled entities data structure from the generated structured dictionary of model elements, wherein said sampled entities data structure includes entity identifiers and sampling dates;
populating, using a target agent executed by the processor, a core set data structure from the defined sampled entities data structure, wherein the core set data structure includes one or more of one or more target activity occurrence determinations, or one or more target value calculations; and
generating, using a modeling agent executed by the processor, a serialized trained model artifact and performance reports from the core set data structure.

19. The non-transitory computer-readable storage medium of claim 18, wherein said instructions for populating the core set data structure from the defined sampled entities data structure comprises joining the sampled entities data structure with one or more target data tables for preserving all entity-date pairs.

20. The non-transitory computer-readable storage medium of claim 18, further comprising instructions for generating, using an attributes agent executed by the processor, one or more training datasets.
